(19) United States
(12) Patent Application Publication
(10) Pub. No.: US 2016/0184067 A1
(43) Pub. Date: Jun. 30, 2016

(54) ORTHODONTIC ANCHORING METHOD AND APPARATUS

(71) Applicant: Justin Parker, Salt Lake City, UT (US)

(72) Inventor: Justin Parker, Salt Lake City, UT (US)

(21) Appl. No.: 14/586,317

(22) Filed: Dec. 30, 2014

(51) Int. Cl. A61C 13/15; A61C 7/12

(52) U.S. Cl. CPC A61C 19/003; A61C 7/12

(57) ABSTRACT

An Orthodontic system which uses curable resin ropes known as Flex fit modules (FFM) to connect, via fasteners, between different components of an orthodontic system including orthodontic appliances, orthodontic axillaries, and anchorage devices. The FFM(s) is designed to be fit to or around the anatomy of the oral cavity and allow connection of the FFM(s) to orthodontic appliances, teeth or orthodontic auxiliaries, then after curing and becoming ridged and fixed are used for the purpose of applying or inhibiting orthodontic movement of teeth and oral structures during orthodontic treatment.

### RELATED APPLICATIONS

This application is a continuation-in-part patent application of the patent application entitled “Orthodontic Appliance Anchoring Method and Apparatus”, Ser. No. 13/716,167 filed Dec. 16, 2012, which is a continuation-in-part patent application of the patent application entitled “Orthodontic Appliance Anchoring Method and Apparatus, Ser. No. 13/487,822 filed Jun. 4, 2012.

### BACKGROUND OF THE INVENTION

1. Field

This invention pertains to orthodontic anchoring and appliance attachment systems. Specifically, it refers to an orthodontic anchoring and attachment method for teeth connected to orthodontic appliances. These are custom appliances designed on demand by the orthodontist for the anchorage needs and/or appliance development during one visit (after separation for bands in some instances) at the orthodontist. These appliances are affixed to temporary anchorage devices (TADs) and/or teeth and/or orthodontic appliances. Each custom appliance has in common a choice of mechanical fasteners with one or multiple orthodontic auxiliaries and, at least one flexible fit module (FFM), which is a flexible curable resin rope and/or a Flex fit wafer (FFW), which is a connecting, or tissue contacting component of an appliance. The mechanical fasteners can be fitted to all traditional orthodontic appliances/auxiliaries. The FFM is placed between any of these fasteners to complete the appliance connection between the tissue and said FFM and tissue born parts of the appliances, which are completed using an immediate curing acrylic wafer know as a Flex Fit Wafer (FFW). This invention simplifies orthodontic mechanics used by the orthodontist for tooth movement and alignment creating never seen before appliances, which incorporate current orthodontic auxiliaries, and blend them into a new innovative system. Fasteners are placed on teeth, TADs or appliances. Then segments of the FFM are adapted around the anatomy of the mouth to join fasteners together or to the FFW as required by clinical choices made by the orthodontist. Once the appliance is designed, adapted and fitted to the patient, it is cured to become a rigid leverage point or points to withstand oral and orthodontic forces required to move teeth. Tooth movement is simplified and made more efficient while time is minimized and patient comfort is improved.

2. State of the Art

Orthodontics and Dento-facial Orthopedics deal in the treatment of malocclusion (improper bites), mal-alignment of teeth and manipulating jaws during growth or with surgical intervention to improve oral facial esthetics, function, and oral health. Comprehensive orthodontic treatment utilizes many intra-oral and extra-oral appliances to achieve corrective measures. Most commonly orthodontic brackets are bonded to teeth and metal wires are inserted into the orthodontic brackets (dental braces), which are made from various metals or a more aesthetic ceramic material or may be achieved by clear removable aligners. The wires are generally affixed with elastic or metal ligatures and interact with the brackets to move teeth into the desired positions. Orthodontic appliances have historically been connected via custom bent wires and continue to be connected from the teeth to the auxiliaries and/or appliances through laboratory procedures.

Stainless steel arch wires can be bent, shaped, and tightened to achieve desired results. Newer Nickel-titanium arch wires and other temperature-sensitive materials are routinely used for this purpose, but do not require bending. When cold, the arch wire is limp and flexible, easily threaded between brackets of most configurations. Once heated to body temperature, the arch wire will stiffen and seek to return to its original shape. These arch wires create constant light forces on the teeth. Brackets with hooks can be placed, or hooks can be added to the arch wire to affix elastics to pull teeth into alignment. The placement and configuration of the elastics is determined by the required course of treatment of each patient. Each month or two, the braces will be adjusted and modified as needed. The orthodontist will remove the colored rubber ties keeping the wire in place or the wire may be replaced or modified and rubber ties replaced as individual ties or a continuous chain is used to close space. Tooth positioning appliances are defined as all traditional appliances used in orthodontics including but not limited to brackets, bands, tubes, cleats, buttons, springs, wires, caps, rapid palatal expanders, Nance appliances, space maintainers, trans-palatal arches, distalization appliances, dental orthopedic appliances, custom bent appliances, clear removable aligners, or any other appliance commonly used it the practice of orthodontics.

Temporary attachment devices or TADs are used as anchored points to secure elastics, springs or wire modules bent for a specific purpose. These elastic or metal modules use a TAD, which is fixed to bone and not connected to teeth for anchorage. Teeth are poorer anchor points because teeth move in accordance with Newton's third law—for every action there is an equal and opposite reaction. Thus when connected to large molars, smaller teeth are more likely to move further toward the molars. This creates a problem when a tooth is not wanted. TADs have begun to solve this problem by adding anchorage to a tooth or groups of teeth allowing for biased orthodontic mechanics.

In additional to TADs and ancillary components orthodontics includes removable appliances, headgear, expansion appliances, fixed appliances and many other devices. These adjunctive appliances may be used to move teeth and manipulate jawbones during growth or with adjunctive surgery. Functional appliances, for example, are used in growing patients (age 7 to 14) to modify the jaw and their relationship. This therapy, termed Dento-facial Orthopedics, is followed by fixed multi-bracket therapy (see “full” en.wikipedia.org/wiki/Dental_braces (“braces”) to align the teeth and refine the occlusion (see en.wikipedia.org/wiki/Occlusion (“dentistry”).

In many cases there is insufficient space in the dental arch for all the teeth to fit properly. There are two main procedures to rectify this problem. One is extraction: teeth are removed to create space. The second is expansion: the maxillary arch or upper jaw is made larger by using a palatal expander. The palatal expanders are secured to teeth to direct the expansion along the suture that separates both halves of the upper jaw. This is the suture that opens and subsequently fills in with new bone when a rapid palatal expander is used.

A number of devices are employed with round steel wires attached to fitted bands around teeth to direct forces and move teeth to correct a patient's bite. For example, Cope, U.S. Pat. No. 7,717,707 issued May 18, 2010 discloses an Orthodontic trans-palatal intrusion arch assembly secured with TADs to close open bites. It employs a number of trans-palatal arch wires connected to molar bands and TADs to direct forces along desired segments of the mouth. These wires are custom bent and formed to the patient and do not necessarily form a perfect fit. Consequently, additional welding and adjustment and/or lab work are required, resulting in multiple fitting visits. Cinader, Jr., U.S. Pat. No. 7,774,084 issued Aug. 10, 2010 creates a method by which implants can be placed more accurately using a template created with the aid of computers. The doctor can place TADs or other types of implants more accurately with this template technology device.

Conventional appliances must be welded and bent to fit the anatomy of the oral cavity. This requires: 1) separation to create space to fit bands, 2) fitting bands or brackets in the office and taking impressions of the teeth, 3) placing the fitted bands/brackets into the impression and 4) sending it to a lab for custom bending of steel wires, soldering of the wires to connect component of the appliance and/or making acrylic components of the appliance. After the laboratory production is completed the patient is brought back in to the orthodontic office where final bending adjustments are made to the appliance by the orthodontist allowing for 5) placement of the appliance. Typically these appliances contain brackets or bands fitted with hooks and bars welded in place from teeth to TADs or other appliances. These can be affixed to the arch wire, bracket or TADs to secure to elastics, springs etc. to move teeth into alignment. This can result in ill-fitting jerry rigged devices, which can be uncomfortable for the patient and not ideal for the orthodontist.

The custom device and method described below avoids these problems by providing an easily fitted FFM connected to an anchoring system associated with TADs and/or appliances to the tooth/teeth. This FFM replaces the stainless steel wire and connects the different components of the appliance, and allows for immediate placement of an efficient, comfortable appliance with no lab work or impression requirements. The FFW replaces the acrylic portion of the appliances and fits together with the FFM to create some of these new appliances. It may also serve as connecting medium to transition from FFM to adjustment wire, spring or other adjustment requiring components of any given appliance. This invention creates a new category of appliances to simplify orthodontic mechanics used to align teeth without welds, bending of wires, or multiple fitting visits. It thus alters current orthodontic practices, saves time, impressions and is beneficial to the patient and the Orthodontist.

### OBJECTIVES

Some of the objectives of the present invention are to:

1) Create a new system to attach to and utilize temporary anchorage devices TADs for anchorage and revolutionize the attachment of traditional orthodontic appliances to teeth.

2) Simplify and generate efficiencies to any challenging orthodontic mechanics by allowing controlled up righting of teeth (including molars), and space closure of tipped molars by placing a bracket suspended in space and fixed to a TAD where the orthodontist would have the bracket if the tooth were ideally placed. Easily creating TAD assisted stops anywhere needed by the orthodontist. This invention assists the orthodontist with many difficult orthodontic procedures including but not limited to: canted occlusion, impacted or un-erupted teeth, intrusion, extrusion, expansion, space closure or opening, and fixed stabilization of a tooth or teeth when movement is not wanted and additional anchorage is desired for optimal vector alignment.

3) Decrease treatment time and patient compliance requirements by improving the use of TADS which are screws inserted into the bone between the teeth for increased anchorage or to create points of fixed anchorage which can be manipulated to the advantage of the Orthodontist to move teeth.

4) Enhance utilization of traditional appliances by changing the way the appliance are fit and connected together using one or more flex fit modules (FFM) or flex fit wafers (FFW), which are flexible curable resin ropes and immediate acrylic anatomy adapting tissue and appliance interfaces respectively. One of a variety of clamps may be attached to traditional bands, brackets, appliances, TADs etc. These clamps and FFM, FFW are connected together providing a platform by which the orthodontist can adjust auxiliaries from TADS and/or appliances to the current brackets and systems to bias the orthodontic mechanics for the benefit of the patient and orthodontist. The orthodontist is now able to replace current appliances with one-visit appliances, which serve the same general purposes of their traditional counterparts. The appliances can be replaced with this new technology for nearly all traditional orthodontic appliances commonly used in orthodontics today.

5) Employ TADs used in conjunction with traditional brackets, wires, invisible removable aligners, and appliances to move teeth into the desired alignment by creating a new category of appliance or attachment apparatus.

6) Remove the requirement of impressions, lab work, utilization of preformed or custom bent wire used to connect appliance parts, and aftermarket soldering currently required to make and properly place orthodontic appliances. The FFM works in conjunction with or can entirely replace the wire or wires used to connect components of orthodontic appliances. The FFW replaces all acrylic portions of traditional appliances and or allows for connection of the FFM to expansion screws or stainless steel wires embedded into the FFW during fabrication. These stainless steel components of the appliances allow for activation of the appliance during orthodontic treatment.

Specifically, this invention provides attachment devices from the TAD to a tooth or teeth either directly or indirectly. It also provides the ability to attach from a TAD to a free-floating point (bracket, cleat or tube) in space cantilevered to where the tooth is desired to arrive. This invention is also used to stop undesired movement by being placed mesial or distal (in-front or behind) of a bracket and then being activated by traditional orthodontic mechanics to move teeth, thus avoiding undesired movement of anchored teeth. Between these new attachment devices a new flex fit module (FFM) is utilized to adapt to the anatomy of the oral cavity and provide a perfect fitting appliance in one visit with no lab work. The FFM can also be fitted to an FFW which allows for immediate adaptation of the acrylic to the tissue using a prefabricated acrylic pad which is perforated and thus adapts to the shape of the palate or teeth and has embedded into it the required hardware to allow the functionality of each appliance to be preferred by the orthodontic specialist.

### SUMMARY OF THE INVENTION

The invention comprises orthodontic TAD attachment devices, tooth attachment devices, and appliance attachment devices such as the flex fit wafer (FFW) and associated sleeve clamp, clip and channel or embedded groove technologies, all connected and fitted to a tooth or teeth (via brackets/bands) and an associated orthodontic appliance and/or auxiliaries with Flex Fit Module (FFM) curable resin ropes. Examples of orthodontic appliances and/or auxiliaries are tubes, brackets, buttons, cleats, fastener clamps sleeves, flex-fit wafers or any combination thereof. The attachment is made using a clamp which connects to a Flex Fit Module (FFM) (curable flexible resin rope) at one end, which is then shaped to the patient's oral anatomy and fastened to another auxiliary clamp to attach to a tooth, appliance, TAD or be set to a point in space toward which the tooth will be moved. The FFM may also be connected to a flexible perforated prefabricated acrylic pad (FFW) with grooves, sleeves, clips or clamps to connect the FFW (tissue born portions of these appliances) to the necessary hardware and orthodontic auxiliaries to allow activation when required. The FFM replaces the wire traditionally used to connect components of orthodontic appliances from TAD to tooth to appliance in any combination. The FFM replaces the tissue born portion of the appliances or serves to connect portions of appliances together being non-tissue born or serves to directly contact the hard or soft tissue of the oral cavity. TAD, tooth, and appliance connections are custom designed and can be formulated in any order and number of attachments (connected to TAD, tooth, appliance) in any configuration to any part the oral cavity.

This invention is functionally efficient, and comfortably attached to one, two or multiple teeth and/or TADs and/or appliances by a clamp, sleeve, clip or flex fit wafer designed for that specific use. The invention also modifies current appliances by adding clamps, sleeves, clips or embedded acrylic grooves (FFW) to them. These clamps, sleeves, clips or embedded acrylic grooves (FFW) are then fitted with FFM's, which are shaped and connect to teeth, which are also fitted with clamps, sleeves, clips or embedded acrylic grooves within the FFW. The apparatus can attach to the orthodontic appliance via the arch wire, which may pass through a tube (round or rectangular) that is part of the clamp. This tube is fitted to the mechanical fastener (clamps, sleeves, clips or grooves (may require FFW)), which provides immovable stop to hold teeth in a particular position within the dental arch.

The connectivity from teeth to TADs or appliances using cut to length, flexible curable FFM flexible resin ropes (FFM) and curable adaptable acrylic pads (FFW) have not heretofore been employed. Adaptations of this appliance are fit and molded to the patient's oral anatomy and cured via heat, time, chemical or light curing, which fixes the apparatus between all its various custom attachments in place creating a newly place fixed custom appliance. The invention allows for a simple more precise use of forces on braces, arch wires, and teeth or the appliances used to align teeth. Thus, this new anchoring and or tooth moving appliance provides vectors with fewer unwanted side affects to align teeth using braces, arch wires, orthodontic appliances and auxiliaries. The orthodontist can design biasing pressure as needed to obtain selective movement of teeth.

At any end of FFM or flex fit module or flexible resin ropes may exist one or more of the following: fastening device or connection apparatus which allows the FFM to be attached from a tooth or teeth to an orthodontic appliance, orthodontic hardware or orthodontic auxiliary for the purpose of applying forces or limiting forces to hard or soft tissues of the human oral cavity. The fasteners are affixed to teeth or orthodontic appliances, orthodontic hardware or auxiliaries and accept the FFM resin rope which is adapted to and around oral structures or orthodontic appliances in a configuration which is preferred by the orthodontist. The system is then cured to create a ridged fixed configuration to accept, apply, create or diminish orthodontic forces. These ropes and fasteners can be connected to orthodontic appliances and oral structures in any way need to create orthodontic appliances custom to each patient on any oral hard or soft structure in any configuration.

The FFM flexible resin ropes are usually made of dental-resin composite suspensions of strengthening agents, such as mineral filler particles, in a resin matrix. These composites are sometimes characterized as micro-filled, macro-filled or hybrid composites. Micro-filled composites have reinforcing fillers with a mean particle size of about 0.05 μm or less. These spherical primary particles are characterized as ‘micro-fillers’ with dimension structures below 100 nm. They are made from fumed silica, which typically tends to aggregate depending on the filler, which show thixotropic thickening effects, which reduce the maximum possible degree of filler content in the composite and compromise handling properties. Consequently, the filler loading is limited to about 45% by volume or 50% by weight. Due to the low loading, the filler particles are not substantially in contact with one another. The strength of the resin matrix contributes significantly to the total strength of the composite.

As stated in the Journal of Biomaterials Science 20 (2009) 1831-184, entitled “Physical Properties of a Hybrid and a Nanohybrid Dental Light-Cured Resin Composite” by Irini D. Sideridou, Maria M. Karabela, Christina N. Micheliou, Panagiotis G. Karagiannidis, and Stergios Logothetidis, Micro-filled composites are structurally weak, limiting their use to low stress restorations; they are typically used for cosmetic restorations due to their ability to retain surface luster. Macro-filled composites typically include reinforcing fillers having an average particle size greater than about 0.6 m and a filler loading of about 60% by volume or 70% by weight. At these high filler loadings, the filler particles begin to contact one another and contribute substantially to the reinforcing mechanism due to the interaction of the particles with one another. These composites are stronger than micro-filled composites and are typically used for stress-bearing restorations

Another class of dental composites is the hybrid composites, which have the features and advantages of micro-filled and macro-filled composites. Hybrid composites contain a broad range of particle sizes. A wide range of particle sizes can lead to high filler loading with resultant high strength. Typically hybrids contain a filler having an average particle size of 0.6 μm or greater and a filler having an average particle size of about 0.05 μm or less. The filler loading is about 70-80% by weight.

The resin components have a solid, semisolid or non-solid consistency. Encapsulated core materials may contain resin absorbing or non-resin absorbing fibers, resin impregnated fibers, gels, gel fibers, flakes or particles to enhance handling or strength properties of the flexible resin rope.

Completed resin ropes may contain one or more of the following layered in any number, order or thickness: a liquid, semi liquid or non liquid resin component, strengthening resin absorbing particles or fibers, strengthening non resin absorbing fibers or particles structural or strengthening wires, exoskeleton structure, endoskeleton structure, encapsulation wrap, perforated or non-perforated stent like metal mesh structural components, plastic or other woven fibers for structural integrity in any configuration, rubber or plastic tube, resin or partially cured tube, partially cured or completely cured resin components, all components of any shape and size and with perforations, cuts, holes, voids or segments where required for the strength, flexibility, malleability and curability with visible or non-visible light.

One embodiment of the FFM flexible resin rope is of any cross section consisting of a dead soft and/or pliable and/or flexible exterior matrix of metal mesh or any other material with spacing akin to a stent of framework or lattice pattern. It provides structural integrity holding the manipulation of resin rope and its adaptation around the anatomy of the hard and soft tissues of the oral cavity. The exterior matrix encases a center lumen of curable resin or resin components including any light cured resin with or without embedded cords, fibers or wires of any material. These materials are flexible and embedded in a gel or liquid contained within the lumen of the resin rope. The center lumen components collectively are flexible and malleable during the initial uncured liquid or gel phase and once cured they become fixed, hard and stiff holding the shape of the previously manipulation and ready to accept orthodontic forces. The FFM flexible resin rope with its inner gel liquid lumen embedded with fibers and the outer stent-like framework comprises one complete curable cord, which may or may not be wrapped or encapsulated by a thing membrane of material. The thin membrane holds in place one or more of the following: fiber/string/cords/wires of any material, light cured resin of any consistency embedded in the contents in the lumen framework and surrounded by the lattice or stent framework.

The FFM flexible resin ropes and curable adaptable flex fit wafers (FFW) with curable adaptable acrylic pads may or may consist of resin absorbing or non resin absorbing fibers, resin impregnated fibers, flakes, or particles that are encapsulated, wrapped, or within a tube made from a fluoropolymer rubber or plastic, any other rubber or plastic or a resin material. The material, which creates the tube like or encapsulated portion of the FFM flexible resin ropes surrounds the internal gel like substance, resin, and/or fibers, flakes or particles material may also be made of any required material. The encapsulation of said internal gel and/or fibers may be made of a bare metal, polymer, nylon, fabric, carbon fiber, bioresorbable or dissolvable mesh wrapping or, or a stent like metal mesh of any metal which serves to wrap or encapsulate and add a flexible, adaptable structure to said FFM flexible resin ropes. The metal encapsulation may be similar in form to a stent used in medicine for holding open vessels in the human body. The metal mesh may have adequate space between the metal fibers to allow light to penetrate the gel, resin, gel fiber or resin fiber components of the FFM. When the FFM flexible resin rope tubing or encapsulation requires more flexibility it may be scored, perforated, or cut at any given depth and in a spiral configuration or any other scoring or perforated design to allow for proper bending dynamics, flexibility, adaptability and functionality in providing ideal connectivity between the FFM tube of any cross section and the components of our various appliances. The scoring may be completed via a rotating jig and a laser to act as a knife to allow for precision and varied designs, orientations, and depths to the cuts around the FFM flexible resin rope tube.

Specifically, the invention comprises at least one FFM curable flexible resin rope of varied diameters and length secured by TADs, teeth (via bands or brackets), FFW(s), and/or appliances, each having mechanical or bondable fasteners structured to secure segments of the flexible resin rope to its end use attachment. The FFM resin rope in a first mode is flexible and of a length to be positioned and adapted within the mouth along desired segments of the teeth, gums, palate and buccal and lingual portions of the oral cavity in both the mandible and maxilla. The resin rope is then attached to another clamp, sleeves, clips or embedded acrylic grooves (FFW) to anchor, attach, or connect to a desired structure, (i.e. TAD, tooth or appliance) in the oral cavity for alignment of the human dentition. In a second mode after being placed in the desired position, the resin rope is cured, with or without a FFW(s), and hardened with light, heat, or chemicals to rigidly hold its position during the application of the biasing pressure to the teeth (orthodontic force). This provides exact placement of desired anchorage points to teeth, TADs, tissue and non-tissue born appliances or points in space for the orthodontist to create desired vectors on teeth. Pulling, pushing, erupting, intruding, rotating, torque, tipping and bodily movement of teeth using braces, arch wires, TADs and tooth straightening appliances using better vector alignment move the teeth more efficiently using forces biased based on the needs of the individual patient.

Orthodontic appliances are currently fabricated of stainless steel components, i.e. screws, pistons with springs, or wire custom bent or pre-formed to serve a function. They are then welded to bands or brackets. This invention can be connected to all of these devices without wires or bending to connect them. This appliance also allows for wires to be embedded into prefabricated FFW(s) as required for activation of certain appliances. This is a one-visit appliance fit utilizing the Flex Fit Module (FFM), Flex Fit Wafers (FFW) and clamps, sleeves, clips or embedded into acrylic grooves in the FFW at both ends of an orthodontic device now connected without custom bent wires.

In one embodiment, the mechanical fasteners are hinged with curved locking jaws structured to secure to segments of flexible resin ropes. This can be repeated with unlimited numbers of locking jaws (clamps) used along any portion of the resin rope. Any attachment can be designed in conjunction with these clamps to serve any anchorage issue in orthodontics. The diameter of the closed clamp may be smaller than the resin rope to create a mechanical lock. This mechanical lock can be achieved with teeth or protruding wedges which bites/penetrates into the FFM tube and/or resin creating a lock from the clamp to the FFM. There are cut outs or windows in the clamp to ensure the flexible rope is cured properly. The windows also serve as mechanical locks because some of the FFM flexible tube or resin protrudes into the cut outs or windows and extends past the clamp and around its borders to mechanically lock it in place as it is closed. Flowable resin may also be placed around FFM or inside fasteners to bond the connection together and utilizing all mechanical features as mechanical locks surrounded by a flowable composite resin. Using these principles the ropes/FFM and jaws/clips, sleeves, or embedded acrylic grooves (FFW) can have any required diameters to meet the force required by a specific anchorage issue or a particular appliance to be fitted with this system. The FFM can also be made in different shapes including (but not limited to) rectangular, oval, square, etc. cross-sections. The clamps, sleeves, clips or embedded acrylic grooves (FFW) may also be fabricated in different shapes to accommodate the FFM and the grooves etc to accommodate the FFM with in the FFW.

In another embodiment, the TAD is inserted into the bone with its head protruding out of the tissue. A cap that fits over the head of the TAD is fitted with a clamp (one piece), which accepts the FFM and is placed on the TAD. A bracket or band also fitted with a clamp is bonded to a tooth. The FFM is cut to length and shaped around the anatomy of the mouth from clamp to clamp. The jaws of the clamps are closed and the FFM between the clamp on the tooth and the clamp fixed to the TAD are cured. After curing the device becomes a solid system anchoring the tooth with the TAD. This system can be repeated using any appliance used in orthodontics, which is fitted with a clamp to any tooth fitted with a band or bracket fitted with at clamp. It is also possible to attach between these two ends another fastener/clamp fitted with any auxiliary such as hook or bracket to the FFM for orthodontic use. An FFW may or may not be incorporated into this system simply by inserting the FFM into clamps, sleeves, clips or embedded acrylic grooves attached to the FFW to allow for tissue born components of this system or allow for connections between this system and appliances associated with this technology.

Mechanical locking devices or clamps or clips can be configured as closing jaws or snap fit covers where two separate pieces snap together to form the clamp with teeth to bite into the resin rope and fix the FFM mechanically in place. (As seen in cross section of expansion screw shown in FIG. 4b) Clips can be fabricated in any shape, size or number to allow for required orthodontic forces of the appliance.

At least one curable flexible resin rope has segments secured by the mechanical locking devices in a first mode where the rope is flexible for positioning within the mouth and contoured around the anatomy of the oral cavity of the patient. Various auxiliaries (cleats, tubes brackets, springs, FFW(s)) can be positioned around the mouth and in conjunction with traditional orthodontic appliances to created beneficial placement to aide in the alignment of teeth and to modify growth of the jaws, when appropriate. Once in position the custom appliance including the curable resin rope (FFM) and its fasteners are cured into one piece and hardened with light, heat, or chemicals to rigidly hold its position. Biasing pressure is then employed to prevent some teeth from moving while encouraging movement of other teeth using a TAD or Multiple TADs for anchorage.

One embodiment of a mechanical locking device has hinged jaws with teeth that interlock when closed to secure around a desired segment of the flexible resin rope. The hinged jaws include at least one opening through which a portion of the resin rope protrudes into when the jaws are closed to prevent the rope from slipping, when hardened. The diameter of the FFM may be larger than the jaws when closed. In another variation the locking jaws can be of the same diameter of the FFM, if the inner part of the jaws are structured to provide retention through a mesh pad system to lock the resin in place when cured. Resin can also be added to the system to increase retentive mechanics. These can be fabricated in any shape or size to accommodate manufacturing, forces or comfort of the patient.

The mechanical locking device may include an orthodontic tube or central channel structured as to allow an arch wire to slide through. It may also be fitted with a bracket, cleat, or hook to which springs or elastics may be affixed to apply vector pressure. In another variation, the shape of the central channel of the slide is rectangular as shown in FIG. 6 or round as shown in FIG. 5 to slide or secure to the arch wire to prevent its twisting; thus providing rotational force to the tooth positioning appliance and affixed tooth when the arch wire twists.

One embodiment of the tooth positioning appliances comprises teeth (banded/bonded) with hinged jaws to interlock when closed to secure around a desired segment of the flexible resin rope (FFM). The mechanical jaws when shut are of a smaller diameter than the FFM and because windows are cut into the jaws of the mechanical fasteners to allow the uncured FFM to be expressed or protrude through window when jaws are closed. Once cured the mechanical junction is complete. Additional mechanical junctions can be made by inserting the FFM into a sleeve equipped with deforming or biting structure within the luman of the sleeve to physically bite into and puncture, deform or gel with the resin rope chemically to achieve a locking of the sleeve to the FFM. Resin may also be inserted into the sleeve with the sleeve being of the correct diameter to accept the resin in addition to the FFM. Usually the sleeve will also have windows to allow for curing. A FFM may also be inserted into a flex fit wafer (FFW) by a clamp, sleeve or grooves/channels embedded into the acrylic allowing for a mechanical, or chemical resin (if resin is flowed into channel) lock, which when cured becomes a solid unit of FFM combined with FFW.

A cleat, hook or bracket may be affixed to the hinged jaws, FFW, springs or other axillaries to provide another anchoring point for the orthodontist to attach springs, wires, tissue born segments, or elastic components as needed to complete a custom appliance.

In another embodiment, the mechanical locking device comprises hinged jaws with teeth, grooves, dimples, channels affixed and interlocking together (both male and female portions of clamp) when closed to snap and clip together to hold clamp shut and secure around a desired segment of the flexible resin rope FFM. The teeth or grooves inside the clamp are different and used to bite into the FFM itself to lock the FFM in place. These can be of any shape, size or cross section to accommodate the patient.

In another embodiment, the orthodontic anchoring apparatus includes at least four Flex fit modules FFMs affixed with a clipping clamp to an expansion screw in the palate of the mouth. The opposing teeth on each side of the maxillary arch (two teeth on each side of the arch) of the mouth are fitted with brackets with mechanical locking devices (clamps). After the four FFMs are locked into place via the clamps, formed and cured the arch is ready for expansion.

To secure rapid palatal expanders, curable FFM flexible resin rope segments with first ends secured by the mechanical locking devices, sleeves, clips, grooves, holes or channels embedded into one or more flex fit wafers (FFW) or jaws attached to the teeth and to the expander at the second ends. The FFM's in the first mode are flexible and positioned around the anatomy of the mouth to attach both ends of the FFM. Once in position the FFM's are cured and hardened with light, heat, or chemicals to rigidly hold its position to make the appliance solid during tooth/jaw movement. The FFM rope segments, now cured, rigidly fix in position the rapid palatal expander, or expander screw embedded into a FFW(s) so that its separation structure (screw), when activated, applies lateral separation pressure to the teeth to widen the palatal suture of the roof of the mouth. This invention allows expanders to be placed to either a TAD, a tooth, or both using clamps, sleeves, grooves, clips, channels or holes with or without a FFW fit to the expander.

The flexible resin ropes/flex fit modules (FFM) are made of light, heat, or chemically curable resins, which can be mixed with fillers or fibers to form a composite material. The curable resin can include but is not limited to epoxies, acrylates, cyanoacrylates, silicones, polyurethanes, or polyureas. It is preferred that the curable resin be activated by light and be based on acrylate resins with a photo initiator that is activated by either UV or visible light. The acrylate material could be a combination of di-functional and tri-functional resins and are most commonly composed of bisphenol A-glycidyl methacrylate (Bis-GMA) monomers or Bis-GMA analogs. Other functional acrylates can be added as reactive diluents to achieve certain physical properties such as flow-ability for ease of handling. As with other composite materials used for dental composite fillings, the preferred resins typically consist of an oligomer acrylates, such as a (Bis-GMA) or urethane dimethacrylate (UDMA), a reactive diluent, and a filler. Oligomer Bis-GMA analogs can vary with the addition of polyethylene glycol (PEG) monomers incorporated into the molecule. Urethane methacrylate oligomers can also be used with both di- and tri-functionality with or without PEG constituents. Reactive diluents include triethleneglycol methacrylate (TEG); low molecular weight trimethacrylates or other PEG based methacrylates. The compositions vary widely, with proprietary mixes of resins forming the matrix, as well as engineered filler materials, including but not limited to cords, fibers, particles, wires, strings of any material depending upon the composite properties required to complete appliances associated with this invention. The FFM can be made with or without a flexible rubber, plastic nylon, metal, carbon fiber, polymer, fabric, dissolvable tube of varied thickness and cross-section, which encases the resin material and allows for better working properties. This can also be described as a resin filled tube, which is flexible. The tube wrapping the resin can be configured with varied widths and different materials and varied chemical/molecular makeup to adjust its properties. This wrapping may also be scored, cut or perforated at any depth and orientation or patter by laser, or any other means, to allow for smooth contours and flexibility around the components of these new appliances.

Filler materials can be based on organic or inorganic materials. Examples of organic fillers can be nanometer or micrometer size particles of polymers based on polystyrene, nylon, or others. Examples of inorganic fillers can be nanometer or micrometer size particles based on silica, alumna, or other inorganic metal oxides or ceramics. Filler materials are used to adjust key properties of the resins such as mechanical properties and viscosity. Nanomaterials can also be used as fillers, such as carbon nanotubes or nanowires based on metals or metal oxides. A coupling agent such as silane may be used to enhance the bond between the components. Fiber materials can also be added to enhance the mechanical properties of the resin composite. Fiber materials can be made from carbon, glass (silica or other inorganic oxide), polyester, polypropylene, or other polymers and act as reinforcing rods to improve the overall stiffness and strength of the composite before and after curing.

In the preferred embodiment of the FFM, a photo initiator is used to cure the composite material that decomposes into free radicals when exposed to light to initiate the polymerization reaction. Photo initiators that decompose under visible light (wavelengths between 400-700 nm) are typically used in dental composites. Examples of photoinitiators include but are not limited to camphorquinone (CQ), phenylpropanedione (PPD) or trimethylbenzoyl-diphenylphosphine oxide (TPO). A catalyst or co-initiator may be included to control its speed. Co-initiators are typically tertiary amines such as ethyl 4-dimethylaminobenzoate.

All of the same technology used or to be used for the FFM may or may not be applied to the flexi bible fit waters (FFW).

The orthodontic anchoring device thus provides an improved easily fitted resin rope FFM which can be adapted anywhere a metal wire was historically bent and shaped for appliances such as but not limited to space-maintainers, rapid palatal expanders, trans-palatal arches, labial bows on retainers, anchoring systems associated with TADs and tooth positioning appliances. Flex fit wafers may or may not be needed to fabricate these appliances and allow for tissue born appliances to now be fabricated in the orthodontic office in fewer visits. Forces can be directed through the FFM individualized vectors for better alignment of teeth. No lab work, custom bent wires, or multiple fitting visits are required.

The hinging jaws or clamps are just one iteration of other clamps, which will utilize the same overlying technologies and principles but may be different in their design, size, materials or mechanical workings. Likewise the FFM including its resin makeup and it's tube or wrap requirements may be designed to fulfill the same function but can be designed with different shapes, cross-sections, thickness and materials, but used for the same uses described here within.

For example, the invention may be adapted for use with invisalign type appliances. This requires a tooth anchoring structure designed to fit flat onto the lingual or buccal surface of a tooth/teeth via a bracket/band, which follows the profile of the of the anatomy of the tooth tightly as to enable the placement of a plastic invisible removable aligner or retainer over the combined tooth and band/bracket structure. The attachment maintains a thin, low profile tooth attachment bracket/band and continues apically, exiting the invisalign appliance and extends around the anatomy of the soft and hard tissues of the palate buccal/lingual mucosa on either/both the maxilla or mandible. It extends past the border of the overlaid plastic invisible removable aligner so as to be unencumbered by said aligner. At which point, a mechanical clamp accepts the first end of the FFM. Then the second end of the FFM is attached to at least one TAD with a mechanical fastener fitted with an attachment for the TAD (TAD cap). This attachment attached to the tooth has a removable cap placed over the clamps for smooth impression release and/or scanning of the teeth when the attachment is placed on teeth before an impression/scan is taken for fabrication of the appliance. This invisalign orthodontic appliance variation provides anchorage for the tooth/teeth during treatment with invisible removable clear plastic appliances and will allow for biasing forces with the use of invisible removable appliances such as invisalign.

In another embodiment, the tooth anchoring structure is designed to fit flat onto the lingual or buccal surface of a tooth/teeth via a bracket/band, which follows the profile of the anatomy of the tooth so as to not inhibit the placement or removal of a plastic invisible removable aligner or retainer over the combined tooth and band/bracket structure while allowing a fastener to be of one piece to said bracket or band and be connected to an FFM.

This variation may be adapted with an FFM with first and second ends. An attachment with a removable cap, which maintains a thin, low profile and continues apically around the anatomy of the soft and hard tissues of the palate buccal/lingual mucosa on either/both the maxilla or mandible is included to extend past a border of the overlaid plastic invisible removable aligner leaving an unencumbered segment. A mechanical clamp is affixed to the unencumbered segment to accept the first end of the FFM attached to at least one TAD. The second end of the FFM has a mechanical fastener fitted with an attachment for the TAD structured so that the removable cap covers the clamps and the attachment provides a smooth impression for scanning before impressions or scans are taken.

These orthodontic anchoring apparatus with tooth anchoring structures, clamps, fasteners and appliances are made of metal or metal amalgamations/alloys components via mold injection or milling or casting techniques, which may or may not include stainless steel, molybdenum copper, tin, nickel, silver, gold, titanium, aluminum, and other similar materials.

The FFM curable flexible rope may be a resin filled tube. The resin within the tube can be chemically adjusted to achieve different physical characteristics including slump, firmness, wetness, malleability, flexibility, strength, hardness, flowability, curability properties and other relevant properties. The tube surrounding or encasing this resin also can be similarly modified by altering materials or width of tube to change its physical properties for the mechanical clamping or biting into via clamp requirements, and also those other properties mentioned above for the resin.

The clamps mechanically or chemically bond or attach to the FFM when closed. Mechanical clamps physically attach to the FFM via teeth/protuberances/mesh, which clamp into and bite the tube and/or resin components of the FFM. Chemical clamps may bond to the FFM using teeth/protuberances/mesh attached to the clamp to create a physical pressure bonding attachment. The FFM may also interlock through a hole, window or end of clamp, when it is closed, as it will be expressed forcefully when clamp is closed and the FFM will be express through window/hole or end of clamp. If the FFM is such that it is not adequately expressible through the window, flowable resin is added to bond to the FFM and uses the hole as a mechanical lock.

The flex fit module (FFW) is prefabricated and scored or perforated on one side in either vertical or horizontal (or both) directions to allow for it to generally contact fit the contours of the palate or the teeth. A layer of material, which contours to tissue or teeth, is then placed onto the tissue side of the FFW to provide immediate and ideal contact fit. The layer of material is preferably a pad made of acrylic, plastic, resin, rubber, silicone or any other like material to achieve the general contours required of the appliance. Immediate softer, more precise tissue adaptation material can be made from polyvinylsiloxaine impression material, denture reline material, resin, acrylic polymer type, or any other light or chemically cured material. Clamps, sleeves, clips or embedded acrylic grooves connect the appliance to an FFM and these devices can be pre-fabricated in any shape or size to accommodate the appliance requirements.

### DESCRIPTION OF THE DRAWINGS

FIG. 1 is a perspective view of one embodiment of the invention with a TAD mounted along the gum line above the teeth of the maxillary arch.

FIG. 2 is a perspective view of another embodiment of the invention mounted along the palate of the mouth.

FIG. 3 is a perspective view of another embodiment of the invention mounted along the palate of the mouth.

FIG. 4 is another embodiment of the invention mounted to a rapid palatal expander mounted to the upper arch of the maxilla.

FIG. 4a is a cross section of the expansion screw and base of the rapid palatal expander of FIG. 4.

FIG. 4b is a perspective view of the cap or clip of the rapid palatal expander of FIG. 4.

FIG. 5 is a perspective view of a mechanical locking device clamp or jaws attached to a round tube.

FIG. 6 is a perspective view of another mechanical locking device or clamp with a tube with rectangular lumen and button or cleat, which attaches to an end of an FFM.

FIG. 7 is a perspective view of an FFM attached to a mechanical clamp of the cap of a temporary anchoring device (TAD).

FIG. 8 is a top perspective view of another embodiment of a mechanical locking device or clamp.

FIG. 9 is a perspective view of an embodiment of a mechanical locking device or clamp affixed to a band with the ability to be fitted to a tooth.

FIG. 10 is a bottom view of a mechanical locking device or clamp 14 with a lingual bracket, with its associated mesh pad.

FIG. 11 is a top view of the embodiment of FIG. 10.

FIG. 11a is a view of a clamp slightly opened and with locking teeth in the lumen of the clamp, which bite into FFM.

FIG. 12 is a perspective view of an uncured FFM/Flexible curable rope or Flex fit module with an outer encapsulation or tube to contain the FFM resin and fiber components.

FIG. 13 is another perspective view of a randomly shaped and cured FFM of FIG. 12.

FIG. 14 is a perspective view of a bracket attached to the a tooth and fabricated so it is attached to a clamp or FFM fastener below the edges of an invisible removable aligner.

FIG. 15 is a perspective view of a fixed in space removable placement device bent to allow an FFM to be fit from clamp to TAD.

FIG. 16 is an example of a bilateral lower space maintainer application with clamps bonded or banded to teeth and an FFM connected to said clamps and extended forward to a flex fit wafer.

FIG. 17 is an example of a rapid palatal expander fitted with its RPE screw embedded within the FFW(s) and sleeve(s) connected by FFM(s) to another RPE rapid palatal expander using clamps.

FIG. 18 is an example of a trans-palatal arch (TPA) application where brackets or bands bonded to teeth are attached to FFM(s) which attach to the TPA by sleeves or embedded grooves to accept the FFM(s) within the FFW(s).

FIG. 19 is a cross section of FIG. 17 showing an example of spacer technology and tissue immediate adaptive technology.

FIG. 20 is an example of a fixed in space application and the activation process after the placement device in FIG. 15 is removed.

FIG. 21 is a simplified Nance appliance where the clamps are bonded or banded to teeth and the FFM is attached to an FFW fitting around the anatomy of the palate the tissue to hold the molars in position.

FIG. 22 is a Flex Fit Wafer (FFW) with anatomical immediate fit technology, embedded grooves that accept the FFM(s), and an adaptable acrylic and solid portion.

FIG. 23 is another iteration of the RPE utilizing a sectioned FFW with an expansion screw embedded at the midline of the appliance.

FIG. 24 is an example of a spring assembly where the FFM 18 is attached to two tads 14 to secure a spring assembly fitted to a tooth via a band and clamp.

FIG. 25 is an example of a posterior molar intrusion appliance.

FIG. 26 is an example of sleeve technology, which may be incorporated to secure to an FFM.

FIG. 27a is a view of an FFW with cuts which perforate from the tissue side of the appliance and allow for the flexibility of the solid portion of the FFW.

FIG. 27b is a view of an FFW in a contoured state showing the perforations and their adaptability to a given shape.

FIG. 28 is another example of a fixed in space application.

FIG. 29 is another example of a fixed in space application.

FIG. 30 is still another example of a fixed in space application.

FIG. 31 illustrates a bracket affixed as one piece to an end of a curable resin rope.

FIG. 32 illustrates the bracket and FFM clamp fixed one piece connection attached to a bracket with ligature ties.

FIG. 33 illustrates another embodiment of a curable resin rope.

FIG. 34 illustrates an embodiment of a curable resin rope with an internal flexible structural matrix.

### DESCRIPTION OF THE ILLUSTRATED EMBODIMENTS

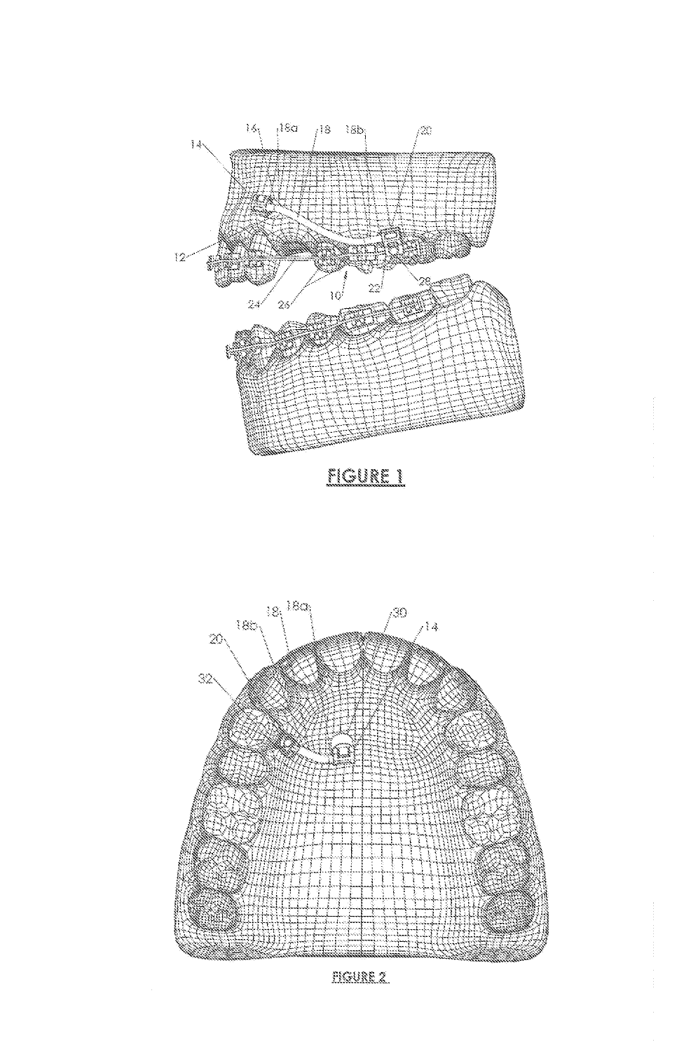

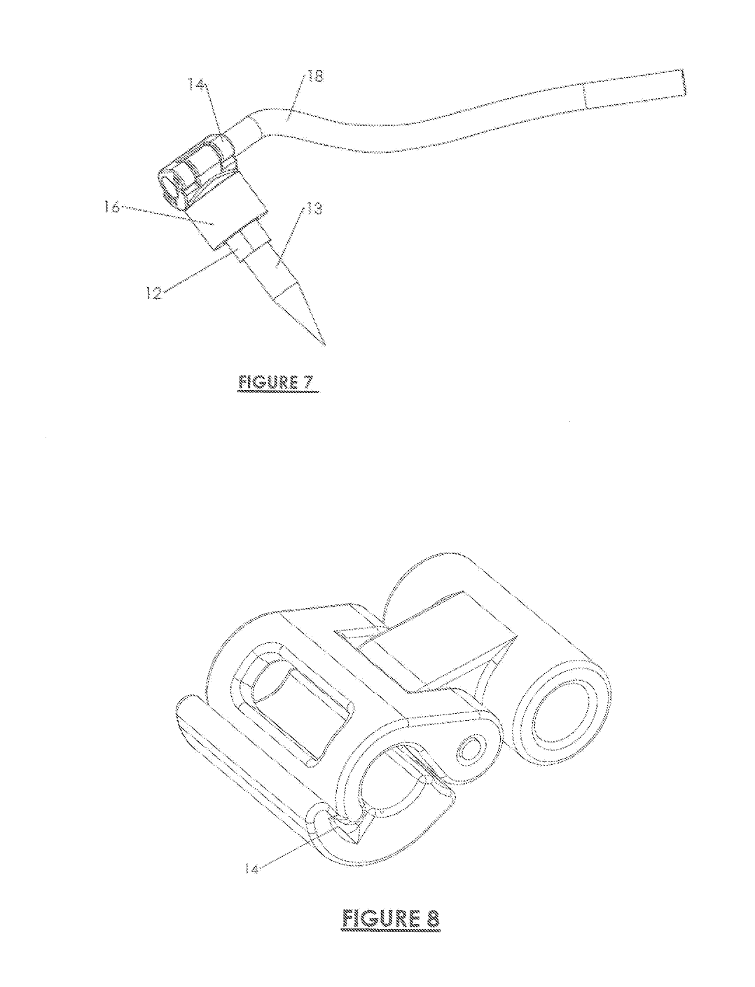

Examples of the present invention are illustrated in the following figures. FIG. 1 is a perspective view of one embodiment of the invention 10 with a temporary anchoring device (TAD) 12 mounted along the gum line above the teeth of the maxillary arch. At the opposite end a tube and clamp 14 fitted through the traditional arch wire 24 system to provide a stop to the molar of which is now fixed in position and will not move when traditional space closing of the missing first bicuspid is initiated. The temporary anchoring device (TAD) 12 is better shown in FIG. 7 with a mechanical locking device or clamp 14 attached to its head 16 positioned between the teeth to the bone to provide a fixed anchoring point. One end 18a of a flexible curable resin rope 18 is secured by the mechanical locking device or clamp 14 of the TAD 12. The other end 18b is secured to a mechanical locking device 20 affixed to a tube cleat auxiliary 22 fitted to a clamp fastener 20, which accepts an arch wire 24, and slides along the arch wire 24 secured by braces 26. This appliance 10 is attached to a TAD 12 above the teeth and to an orthodontic tube 22 with the arch wire 24 passing through the tube 22. This use may require two separate (but joined via FFM 18) TADs 12 to prevent rotation and increase strength of an appliance as shown in FIG. 1.

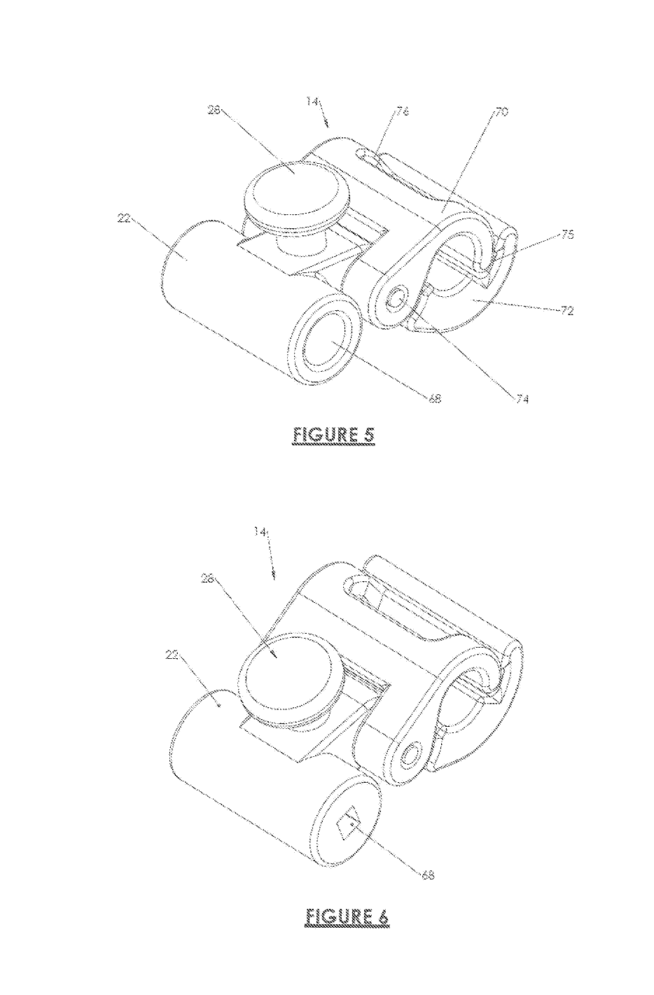

A cleat 28 shown in more detail in FIGS. 5 and 6 is attached to the mechanical locking device or clamp 20 to provide an anchoring point for elastic (not shown). Thus positioned, the resin rope 18 is cured with light, heat, chemicals or time to securely hold rigid the cleat 28 in fixed position to allow the teeth to move in a desired direction.

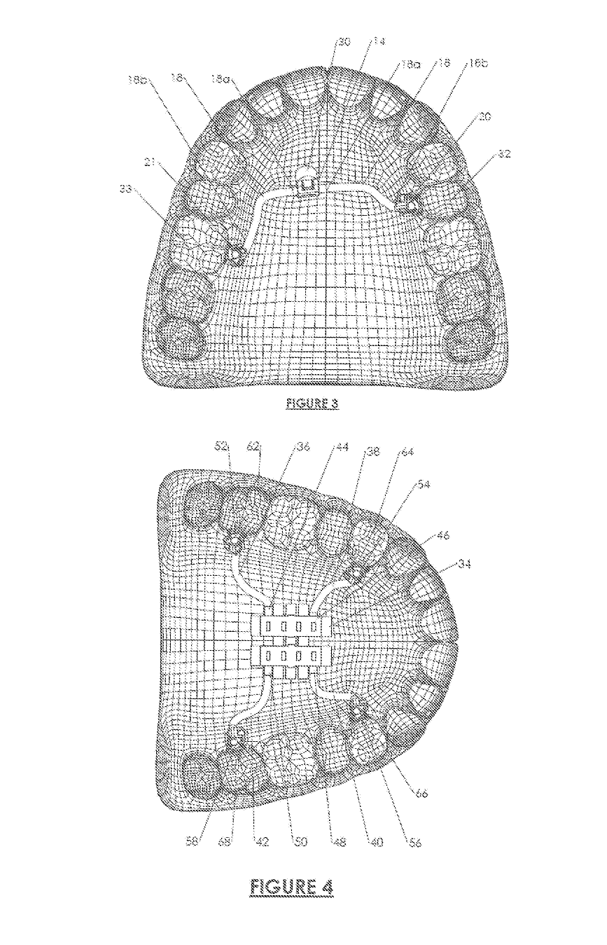

FIG. 2 is a perspective view of another embodiment of the invention 10 mounted along the palate of the mouth with the FFM 18 being connected from TAD 12 to the lingual of the upper right first bicuspid inhibiting said tooth from moving. This tooth can now be acted upon with traditional orthodontic methods and not moved. A TAD 12 with a mechanical locking device or clamp 14 attached to its head 16 (not shown) and a lingual bracket 30 is secured to the roof of the mouth. One end 18a of a curable resin rope 18 is then secured by the mechanical locking device or clamp 14 of the TAD 12. The other end 18b of the resin rope 18 is held by a bracket or band 32 fitted with a clamp or mechanical locking device 20 and bonded to a tooth secured in position. The resin rope 18 is then cured with light, heat, chemical or time to rigidly secure the banded tooth in fixed position relative to the TAD 12

The curable flexible resin rope, flex fit module or FFM, all hereinafter referred to as (FFM) 18, is moldable to the anatomy of the oral cavity and has variable diameters and cross sections selected to withstand biasing forces when cured. The FFM 18 in simple terms is any rope like material, wrapped, encapsulated or with any flexible material, which in a first phase is flexible and adaptable in any anatomical configuration and connects fasteners to auxiliaries in this flexible state, and in a second phase can then be cured and fixed in position or solid state. The FFM 18 can be made with or without a tube structure encapsulating the resin and or fibers, flakes or other material there within to adjust its physical and behavioral properties such as 2,6-Di-tert-butyle-4-methylphenol, Bisphenol A ethoxylate dimethacrylate, PEG 400 Extended Urethane dimethacrylate, Aliphatic Urethane Acrylate, Urethane dimethacrylate, Diurethane dimethacrylate isomers mixtures, Ethyl 4-(dimethlyamino) benzoate, epoxies, acrylates, cyanoacrylates, silicones, polyurethanes, polyureas, oligomer acrylates, urethane methacrylate oligomers, low molecular weight trimethacrylates or other polyethylene glycol (PEG) monomers, Bisphenol A glycerolate dimethacrylate. It is then adapted around the anatomy of the palate and fit to a locking device clamp 20, which is attached to the TAD 12. After curing, it provides complete anchorage for the bicuspid. The FFM 18 may have a rectangular, flat, oval, or other shaped cross-section, preferably adapted to better fit the anatomy of the oral cavity.

This FFM 18 is a new category of orthodontic appliances whose primary functions include:

i. Adaptation to the patient's anatomy

ii. Replacement of current custom bent wires to connect from TAD 12 to tooth, appliance to tooth, tooth to tooth, tad to bracket, tad to band, appliance to band or bracket, band/bracket to auxiliary, TAD 12 to auxiliary, band/bracket to acrylic pad (FFW 82). TAD to acrylic pad (FFW 82), appliance to acrylic pad, flex fit wafer (FFW 82). The FFM 18 is the universal connector for at least one connection in each of the appliances in this invention. Those appliances and concepts illustrated are only a part (some) of the countless possible applications of this technology.

iii. Elimination of lab work fabrication with one visit placement of custom made appliances

FIG. 3 is a perspective view of another embodiment of the invention 10 mounted along the palate of the mouth where the FFM 18 is connected bilaterally and is inhibiting movement of both the upper right first molar and the upper left second bicuspid. This appliance 10 is fitted to a molar and a bicuspid via brackets 32, 33 fitted with clamps 20, 21. An FFM 18 is then adapted from one to the other and another mechanical locking device clamp 14 fitted with a lingual bracket 30 is attached to a TAD 12 secured to the roof of the mouth, holds ends 18a, 18b of the FFM 18 in position. It is then cured to achieve complete anchorage. The resin rope 18 is required to fit together between the attachment ends of all these appliances. Within these scanned images, the flex fitting resin rope (FFM) 18 is easily adapted to the anatomy of the oral cavity. In summary, ends 18a, 18b are secured by mechanical locking devices 20, 21 of tooth bands 32, 33. Once in position, the resin rope 18 is then cured with light to rigidly hold the two-banded teeth in fixed position relative to the TAD 12.

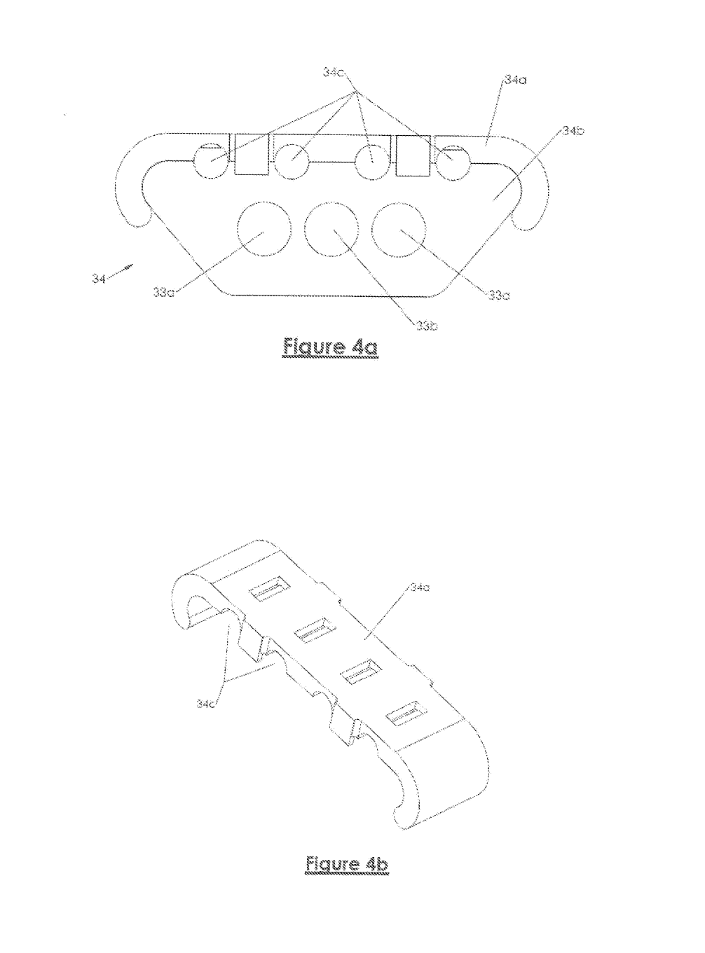

FIG. 4 is another embodiment of the invention 10 mounted to a rapid palatal expander (RPE) 34 mounted to the upper arch of the maxilla with optional clip technology to connect to multiple FFMs 18 to the expansion screw of screw activated rapid palatal expander (RPE) 34 mounted to the upper pallet of the mouth. The RPE 34 is attached to the teeth via bands 62, 64, 66, 68 fitted with clamps 52, 54, 56, 58. FFMs 36, 38, 40, 42 are used to attach the teeth to the screw activated RPE 34. Once ends 52, 54, 56, 58 are secured to clamps 52, 54, 56, 58, and ends 44, 46, 48, 50 are secured by the RPE 34, the FFMs 36, 38, 40, 42 are fit to the anatomy and clamped into by a clip which covers the four FFM(s) 36, 38, 40, 42 and holds them in place. The resultant RPE/FFM appliance is then cured to rigidly hold the rapid palatal expander 34 in position and ready for activation. When activated, the RPE 34 applies spreading pressure to the four teeth expanding the suture of the palate to widen the bite.

FIG. 4a is a cross section of the expansion screw portion of FIG. 4 showing the expansion screw 34b and clip 34a and how they bite into and hold in place the four FFMs 36, 38, 40, 42 by the 4 FFM slots 34c. FIG. 4a is a cross section of the embodiment of the rapid palatal expander RPE 34 of FIG. 4 showing its components 34a, 34b defining slots 34c. The RPE cap 34a is secured to the RPE base 34b to hold the ends of resin ropes FFM 36, 38, 40, 42 in the slots 34c. FIG. 4b is a perspective view of the RPE cap 34a shown in FIG. 4a.

The RPE 34 shown in FIGS. 4, 4a, 4b, 17, 19, and 23 revolutionizes expansion technologies, The RPE 34 can be adapted using various technologies, but when designed as follows provides particularly good results: In one embodiment the RPE 34 is fabricated with clamps similar to those found on all other auxiliaries associated with this technology directly to the traditional RPE screw 34c and then fastened together with cut to length FFM 18 just as with the other embodiments noted above.

FIG. 5 is a perspective view of a mechanical locking device clamp or jaws appliance 14 attached to a round tube 22 for easy insertion of an arch wire 24 through its associated lumen 68 when torque is not required upon activation and including a cleat or button 28, which attaches to elastomeric tie(s), elastic(s), spring(s), ligature(s) etc. (not shown).

This tube clip 22 has a round tube 68 with tubular bore 68 to slide along an arch wire 24. The tube clip may have a rectangular bore 68 as shown in FIG. 6. The locking device 14 has curved hinged jaws 70, 72 held by a pin 74, which are structured to secure there between desired segments of FFMs 18 when locked by the hinged jaws 70, 72. One of the hinged jaws 70 contains an opening 76, which allows the FFM 18 to expand therein when the jaws 70, 72 are closed. When cured, the protruding segment of the resin rope 18 prevents the jaws 70, 72 from sliding along it.

FIG. 6 is a perspective view of another mechanical locking device clamp or jaws appliance 14 with a cleat 28 and slide 22 similar to that shown in FIG. 5. It attaches to an end of an FFM 18 with the associated tube 22 defining a rectangular lumen 68, and an associated cleat or button 28. The cleat or button 28 is structured to attach to elastomeric ties. The slide 22 rectangular lumen 68 rigidly holds to the arch wire 24 so that when it twists rotational pressure is applied to the mechanical locking device 14.

FIG. 7 is a perspective view of an FFM 18 attached to a mechanical locking device 14 structured as a clamp 14 attached to a cap 16 of a temporary anchoring device (TAD) 12 which may or may not have a locking shape 12 to prevent rotation of the cap 16 after insertion. It is called a cap 16 because it caps the TAD 12. It is of one-piece construction with a clamp fastener 14. It may also be fabricated as individual components, which when connected make one piece. The TAD 12 has an anchoring shaft 13, which is temporarily driven or screwed into the bone to secure the TAD 12 in position. The FFM 18 can be fastened to the TAD 12 as seen and shaped anyway necessary 18.

FIG. 8 is a top perspective view of another embodiment of a mechanical locking device or clamp 14 without a cleat 28. It illustrates one possible type of closing clamp 14 with jaws 72, 75 shown in FIG. 5 that click into one another and which has only a round tube 22 attached as an auxiliary, which accepts orthodontic equipment. This perspective view better shows the openable locking structure of the jaws 70, 72.

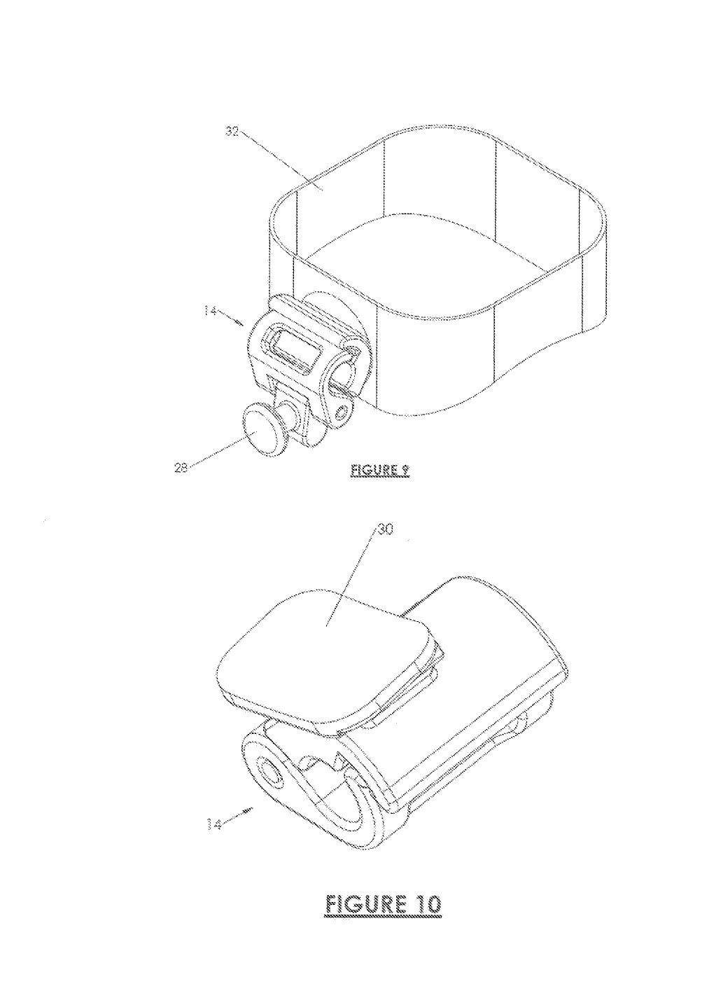

FIG. 9 is a perspective view of an embodiment of a mechanical locking device or clamp 14 affixed to a band 32 with the ability to be fitted to a tooth. It is mounted in a horizontal position but can be mounted in a vertical or diagonal or in any other configuration required.

FIG. 10 is a bottom view of a mechanical locking device or clamp 14 with a lingual bracket 30 showing its associated mesh pad to allow adhesive to penetrate and bond thereon. This is mounted in a vertical position and could be mounted in any configuration required or any size required to fit any and all possible cross sections or sizes of the FFM technology.

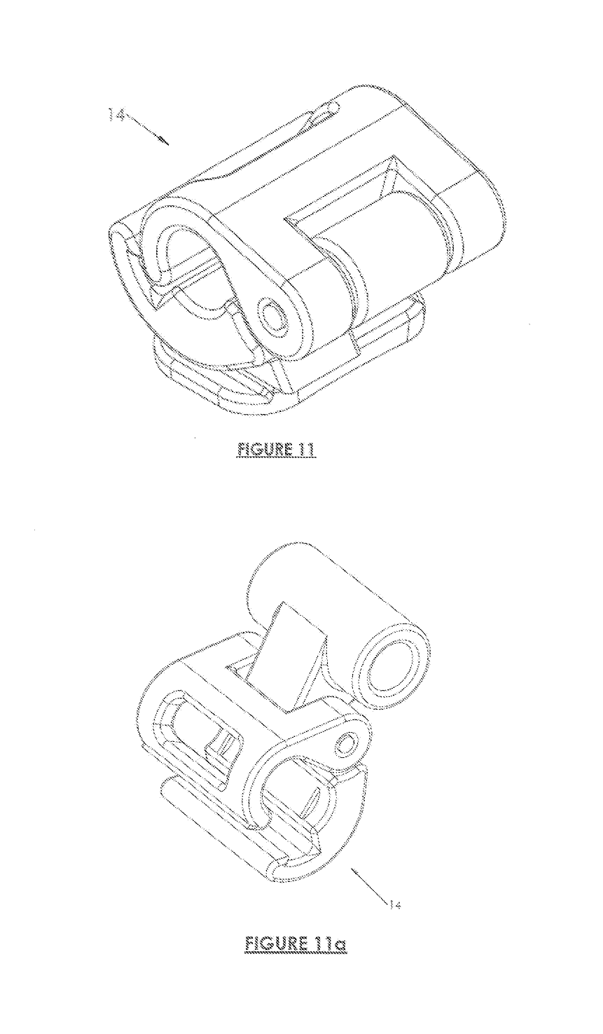

FIG. 11 is a top view of the embodiment of FIG. 10.

FIG. 11a is a view of a clamp 14 slightly opened and with locking teeth in the lumen of the clamp, which bite into inserted FFM 18. It displays the cut hole or window in the clamp 14 to allow ease of curing and mechanical locking during compression of FFM 18 inside clamp. It also shows a combination tube auxiliary 22 where an archwire 24 may be inserted associated with the clamp 14.

FIG. 12 is a perspective view of an uncured FFM/Flexible curable rope or Flex fit module 18 embodiment which uses an outer encapsulation or tube 31a to contain the FFM resin and fiber components 31b before curing is achieved. The FFM 18 may or may not require tube encapsulation.

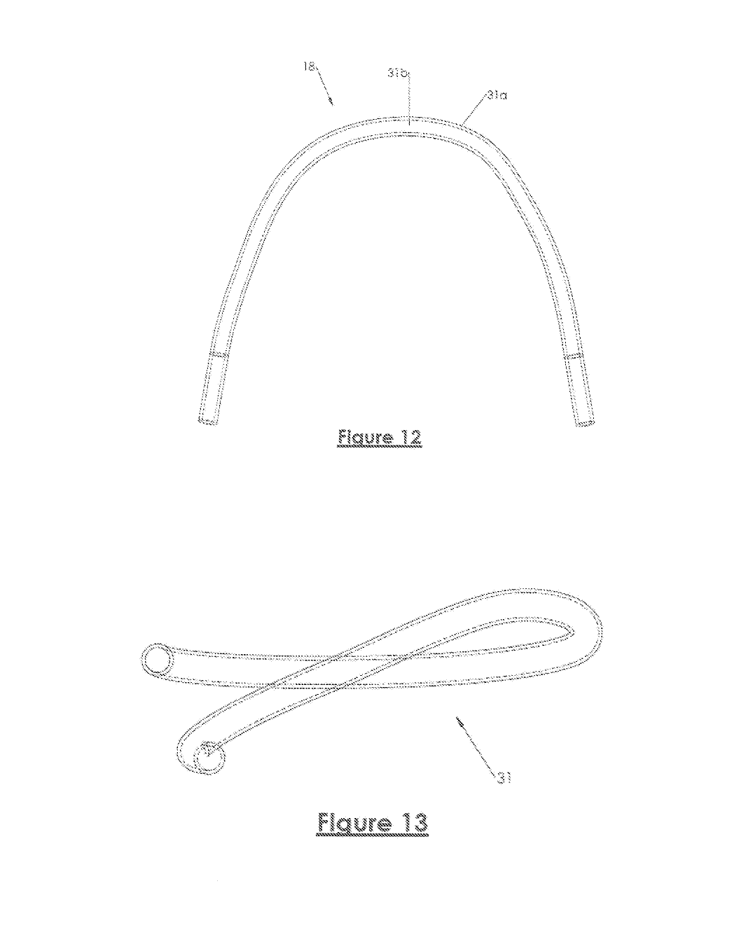

FIG. 13 is a perspective view of a randomly shaped and bent FFM 18, which is cured and the FFM 31 of FIG. 12 holds the manipulated position shown in FIG. 13.

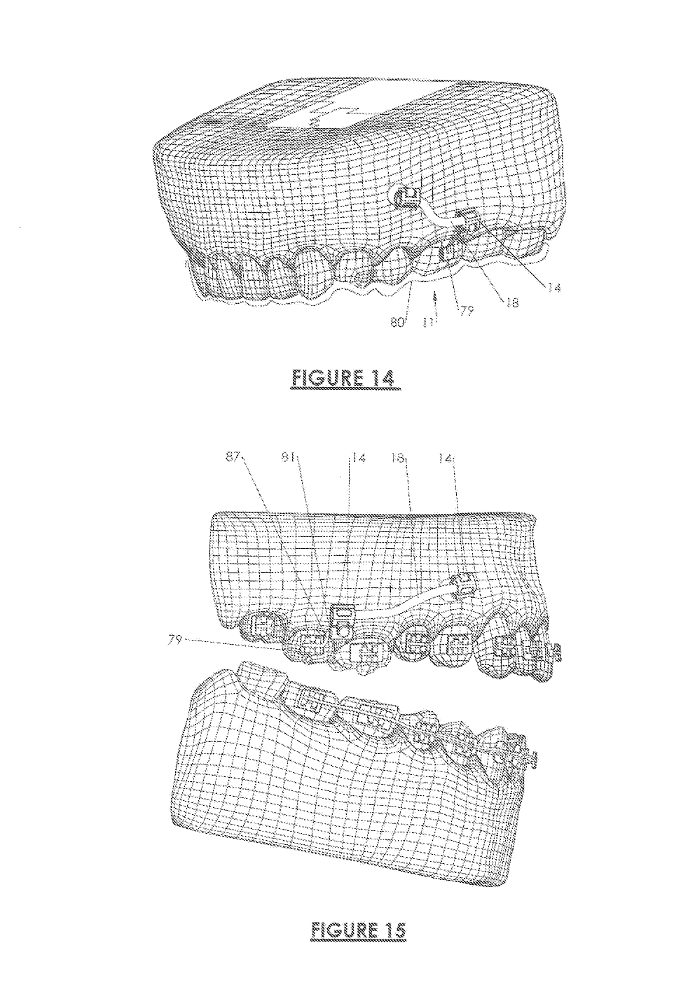

FIG. 14 is a perspective view of invisible removable aligner 80 adapted over a bracket 79 connected to a fastener 14 that remains outside the aligner and can be fitted with an FFM 18 or to any components available with this invention. The aligner 80 fits over tooth and bracket 79 combination easily as to not inhibit the placement or removal of the invisible removable aligner 80 while at the same time holding the tooth in a fixed position. The bracket 79 or bracket on band (not shown) is attached to a tooth and fixed to the clamp apparatus 14 with a solid metal connection, which is part of a one-piece clamp bracket combination. The metal portion extends past the border of the invisible removable aligner 80 to the clamp 14 following the anatomy of the hard and soft tissue, as it becomes a clamp where it is fastened to the FFM 18. Actual braces attached to fastener components 79 may be a variation in size and shape of the bracket and fastener that is shown as 79 in FIG. 14.

FIG. 15 is a perspective view of a fixed in space placement device 87, which is removable and bent to position by an orthodontist to fit into any existing bracket for the purpose of allowing the FFM 18 to be fit from clamp 14 to TAD 12. After the connection is complete and cured the placement device 87 is removed and the auxiliary is ready for activation.

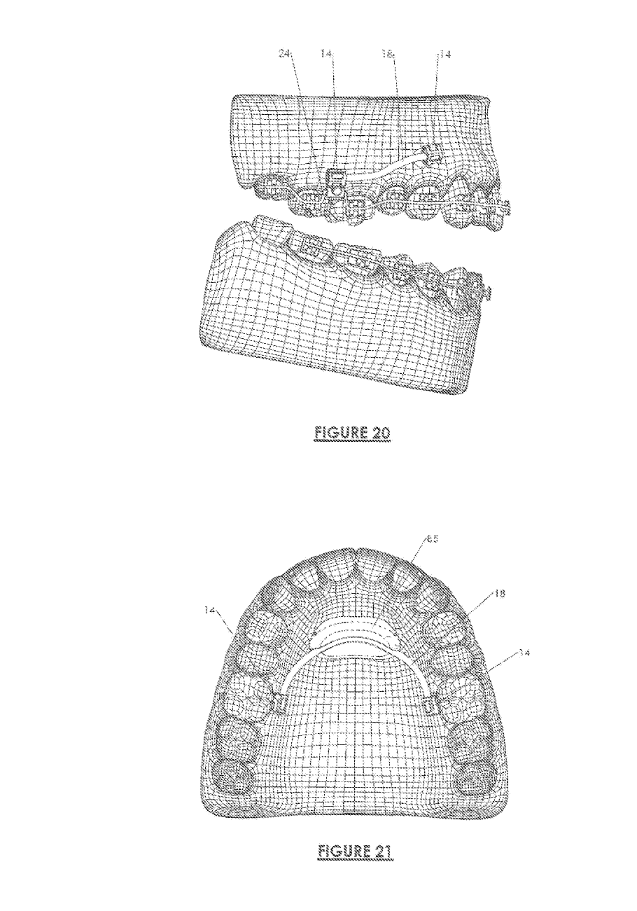

This appliance allows for the much-needed addition to the orthodontist tool chest for straightening teeth. This platform offers solutions unavailable previously and will augment treatment options for the orthodontic patient and quality of orthodontic results. One or more TADS 14 are placed into the bone at any acceptable location, which is not dependent on directional force requirements. The orthodontist measures and estimates an ideal location for fixed in space bracket 14, tube or cleat and bends wire attached to that location. The fixed in space placement device, with all the adjustments completed 87 is placed and ligated (tied) to an adjacent bracket. The placement device now holds tube bracket etc. in place and the fastener and auxiliary are also held in place. Now the FFM 18 is cut to length and placed between the fixed point in space and the TADs 14, which are already fitted with caps to accept the other end of the FFM 18. The appliance is cured and the fixed in space placement device is removed leaving the bracket 32, tube or cleat 28 fixed in space at the location where the orthodontist wants adjacent teeth to be moved as shown in FIG. 20. The device itself is made from a wire, which fits into clamp 52 or tube 68 or cleat 28 or bracket 32 temporarily by a wax or cork or rubber and/or silicone and/or resin and/or plastic. The device is completely removable after placement of the fixed in space auxiliary. This is required because the removable placement device occupies the same space where the wire 94 is to be placed and activation occurs as illustrated in FIG. 20.

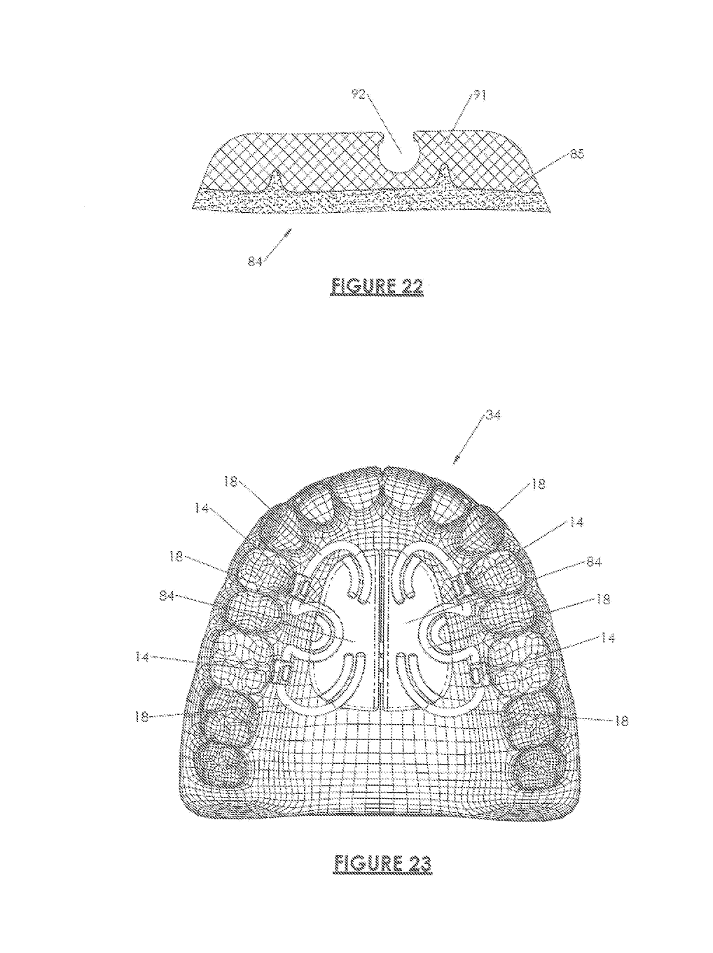

An example of a bilateral lower space maintainer application is shown in FIG. 16. A traditional bilateral space maintainer appliance 83 is vastly simplified using our innovative technologies as shown in FIG. 16. Brackets or bands 32 similar to those shown in FIGS. 9 and 10 with fastener clamps 14 to accept the FFM 18 are placed on the lingual of the mandibular first molars. The correctly sized and prefabricated acrylic FFW 82 shown in FIGS. 22, 27a, 27b accepts the FFM 18 via 1) sleeves 83 or 2) with a central groove 91 shown in FIG. 22 to accept the FFM 18 in place on the lingual surfaces of the lower anterior teeth. With our immediate anatomical fit material 93 shown FIG. 27b on the underside (tissue side) of the Flex Fit Wafer (FFW) 82, it adapts perfectly to the lingual anatomy of the lower anterior teeth and or soft tissue. After the FFW 82 and the FFM 18 are attached and connected to the fastener clamps 14 the appliance is cured and ready to retain space.

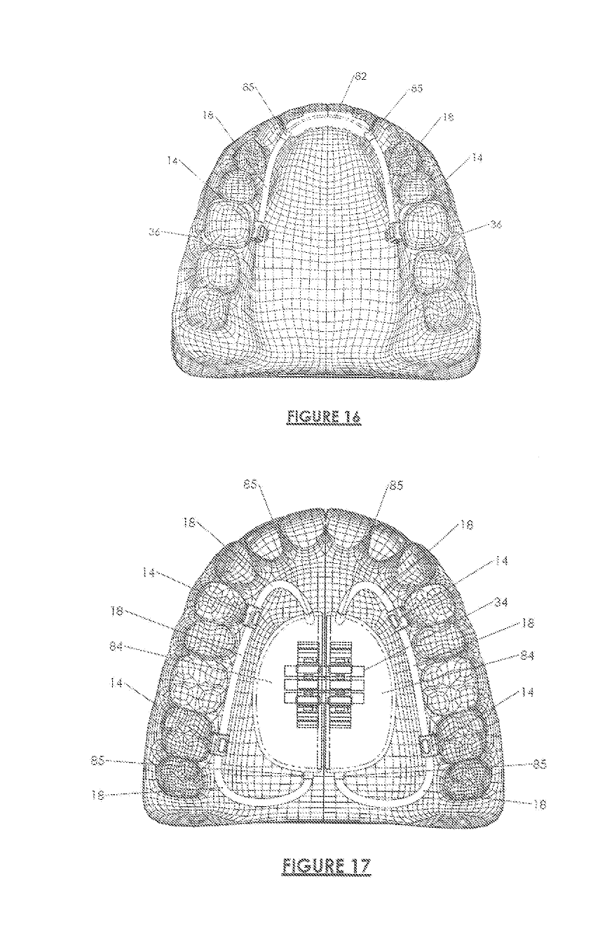

FIG. 17 is another example of an RPE or rapid palatal expander 34, with the FFW 84 with it's associated expansion screw 34c sized, placed and adapted with immediate fit material 85 shown in FIG. 19 on the roof of the mouth. FFMs 18 are fitted from fasteners on teeth 14 to sleeves 83 embedded into the FFM 84. After curing of both the FFM(s) 18 and FFW(s) 84, the appliance is ready for activation.

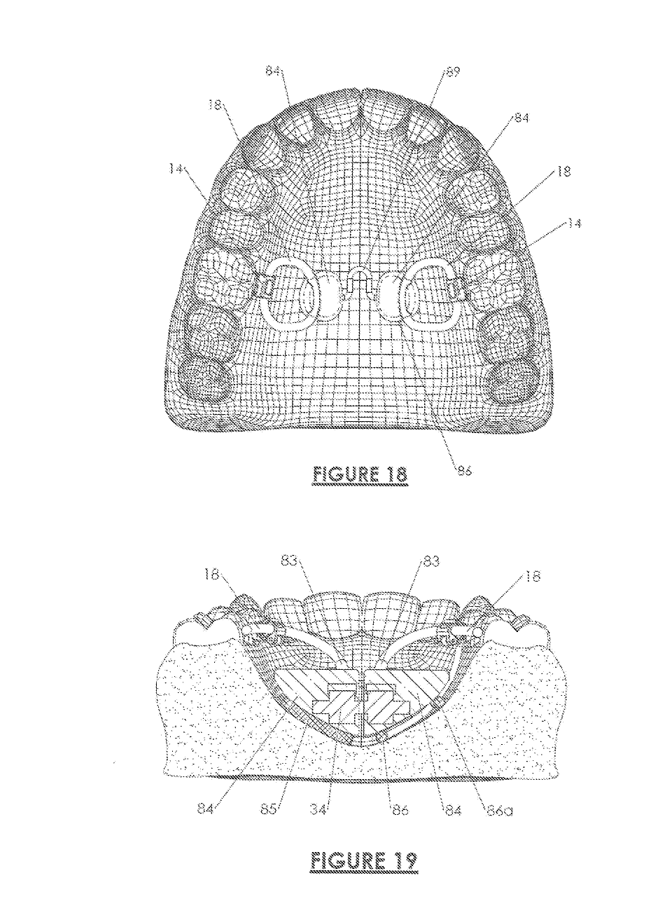

FIG. 18 is an example of a trans-palatal arch application (TPA) employing Flex Fit Wafer technology (FFW) 88 with anatomical immediate spacer technology 86 shown in FIG. 19 because it does not come into contact with the tissue. At the middle of the appliance there is a stainless steel wire 89 embedded into the FFM 18 to allow adjustments to the appliance. Flex Fit Modules FFM 18 are then fit into the grooves of the FFW 88 and brought up into the clamps 14. The clamps or fasteners 14 accept the FFM 18, which are cut to length and placed. This appliance utilizes immediate fit spacers 86 shown in FIG. 19 to keep the transpalatal appliance off of the tissue. This appliance also may be fitted without spacers 88 if the orthodontist holds the appliance away from tissue during curing. After the appliance is cured, the TPA is ready for activation in one short visit.

FIG. 19 is a cross section of FIG. 17 illustrating the immediate fit technology 85 and the immediate space technology 86. Immediate tissue technology 85 shown in FIG. 19 allows material placed on the tissue contacting side of an FFW 88 to adapt and conform to the anatomy of all it comes into contact including the hard and soft tissues of the oral cavity. This material remains in place and is cured with the associated FFW 88 and FFM 18 and becomes one with the appliance. Forces can now be applied to these tissues after the immediate fit technology is employed.

The immediate space technology 86 shown in FIG. 19 is comprised of spacers, which are placed much like a carpet before the appliance is fixed in place. Spacer(s) 86 are implemented temporarily when space is required between appliance 84 and tissue. They are removed after curing allowing the orthodontist to activate appliances and not come into contact with the tissue. The immediate space material 86 is washed out and removed after appliance is cured. Spacer(s) 86 can be of any width required and must be removed after curing of appliance 84.

FIG. 20 is an example of a fixed in space application. One variation utilizes a tube 94, which is similar to tubes used to bond to molars in varied lengths to be placed at any point in space to affect the movement. A fastener 14 can be placed at any point in space including directly adjacent to a bracket or above, below, buccal, lingual, or beyond a tooth either mesial or distal for up righting mechanics. Tooth movements include but are not limited to intrusion shown in FIG. 20, extrusion, buccal, lingual or torque movements. This attachment can be fitted with any traditional orthodontic auxiliary (cleat, hook, tube etc.) or, new auxiliary to best fit the necessary anatomical and functional requirements of the oral cavity and the orthodontist. An FFM 18 is then clamped via fastener 14, which is part of the auxiliary, and attached to one or more TADS 12 with their associated fasteners 14 anywhere the orthodontist locates adequate space for insertion. This cantilevered appliance is then cured and made rigid ready to accept required, wires, elastic modules, and springs to apply orthodontic forces. Notice the nickel titanium flexible wire 94, which now is going to bring all adjacent teeth to the point in space where this appliance was bent in place by the orthodontist. This technology has never been introduced before in orthodontics.

FIG. 21 is a vastly simplified Maxillary Nance appliance using applicant's inventive technologies, which holds the molars in place and from moving forward while patients wait for their bicuspids (teeth) to grow in. Brackets or bands 32 such as those shown in FIGS. 9 and 10 with fastener clamps 14 to accept the FFM 18 are placed on the lingual of the maxillary first molars or other teeth. The FFM 18 is then fitted to the FFW 90, which on the tissue side has the immediate fit technology 86 and is made in several different sizes to accommodate differences in palates among the general population. Once all components are fit together the appliance is cured and ready to accept orthodontic forces or to hold space.

FIG. 22 is a FFW 90 with anatomical immediate fit technology 93 and the embedded grooves 92, which accept the FFM(s) 18. The acrylic or solid portion 92 is flexible and adaptable as shown in FIGS. 27a, 27b. The correctly sized and prefabricated acrylic FFW 88 with a central groove 92 shown in FIG. 22 to accept the FFM 18 is placed at the anterior of the palate. With the immediate anatomical fit on the underside 92 of the FFW 88 shown in FIG. 22, the device adapts perfectly to the palatal anatomy and the rugae found in this area. After the palatal FFW 88 and the FFM 18 are attached to the fasteners the appliance is cured and ready to retain space.

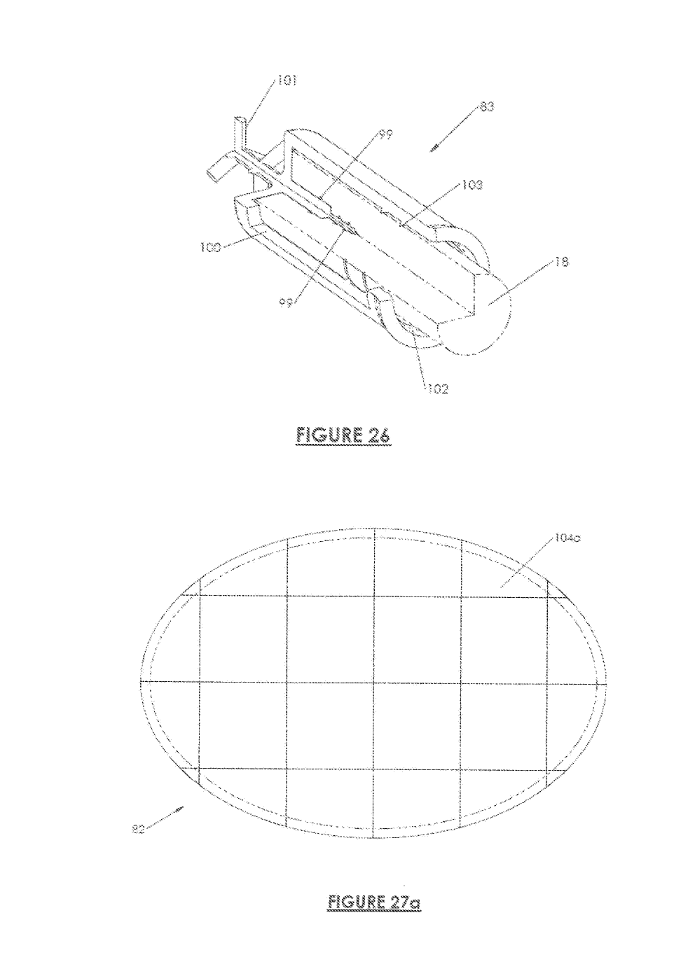

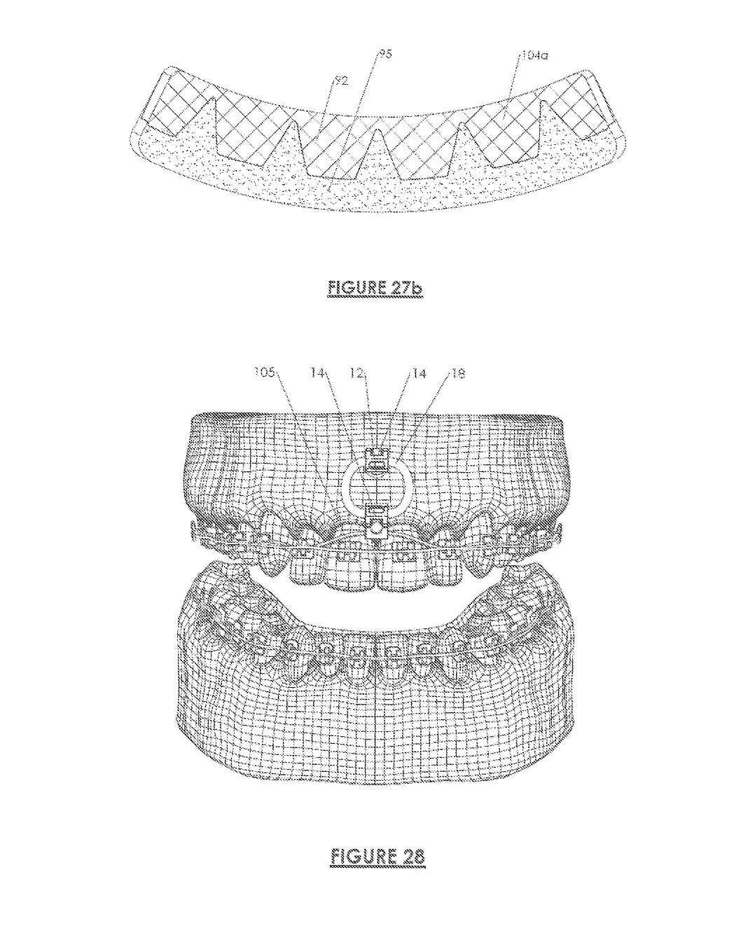

The FFW 90 shown in FIGS. 27a, 27b as 104 allows for the ability to connect the appliance to tissue and to incorporate hardware such as sleeves, wires, screws, channels, cleats etc. The FFW 90 is fabricated in varied sizes are wafers, which on the tissue side is lined with a immediate anatomical fit gel layer 93 which is light cured or time cured or chemical cured. This lining material adapts perfectly to the anatomy of the patient's oral cavity and may be placed onto the tissue side of the FFW 90 by extrusion gun applied by the orthodontist or may be a pre-fabricated appliance with the adaptive liner already incorporated. Perforations are an option to allow the rigid portion of the appliance to be partially flexible as illustrated in FIGS. 27a, 27b. These perforations can be arranged in any manner (depth, width, orientation, direction) to allow for the particulars of the oral cavity. The FFW 90 is attached to other components of the appliances by a channel(s) or groove(s) shown in FIG. 22 or cutout(s), sleeves shown in FIG. 26 and/or metal clamp(s) 14 shown in FIG. 5, 6, or 8, which accept the FFM 18 into the pre-fabricated acrylic pad 93. The FFM 18 then is extended to the fastener clamps 14 bonded to teeth as shown in FIG. 19.

FIG. 23 is another iteration of the RPE 84 utilizing a sectioned FFW 90 with an expansion screw embedded at the midline of the appliance. This RPE 84 and it's associated FFW(s) 90 are fitted with grooves or channels embedded into the solid or acrylic portion of the appliance to accept the FFM(s) 18, which feed through and attach to the channels as well as through the clamps 14 attached to the teeth via bands or brackets 32. The RPE 84 uses an FFM 18 fitted within channels or grooves. It is attached to teeth with clamps 14 securing onto FFM 18, which is then treaded and attached to the FFW 90 by grooves. Notice there are extra grooves that are not being used. They will be employed if the appliance is placed into a different size palate or if different teeth are connected via the FFM 18 to the appliance. The FFW 90 also is equipped with the immediate fit technology, which is cured along with all the associated FFM(s) 18 and components of this RPE 84.

FIG. 24 illustrates an example of a spring assembly 94 employing the technology. This palatal spring FIG. 24 stands out as the most innovative, easy to use, and effective spring technology ever to be seen in orthodontics. It is attached at one end to at least one TAD 14 by the FFM resin rope 18 and then is attached to the spring assembly 94 by a coping, sheath 95 comprising of a male portion 18a of FFM 18 and a female socket of the sleeve 95 at each end of the spring assembly 96. FFM(s) 18 are needed on at least one end of the appliance but the appliance can be redesigned incorporating (FFW or welded springs to bands etc.) technologies or any other technology in this system. It is then are adapted to the anatomy to the palate and into sleeves 95 then on to one iteration of a spring assembly, which then at a posterior point the sleeve 95 attaches to a second FFM 18 and is fitted to a tooth via a band and clamp. This allows for distalization of any tooth abutted against the anchorage of TAD(s) 14.

This spring assembly FIG. 23 also may use clamp(s) fastener(s) 14 as seen on other devices utilizing this technology such as those shown in FIG. 11. The spring assembly 96 is attached to teeth by the other ends of an FFM 18 clamped to brackets or bands 32, 33 adhered to teeth as shown in FIG. 24. This spring assembly an also be attached to a tooth at one end or both ends with or without a TAD. An FFM extends from at least two separate points from the spring assembly to attach to bands, teeth and/or Tads. The spring portion 96 is compressed by sliding a screw portion 97 towards the spring 96 and compressing it to allow for movement of teeth. This appliance may be fabricated using FFW 88 technology similar to that shown on the trans-palatal arch application (TPA) employing Flex Fit Wafer technology (FFW) 88 with anatomical immediate fit technology with grooves at points 95 instead of coping or sheath design. This allows easy attachments from TAD 14 to FFW 88 to Tooth with clamp on mesial of appliances.

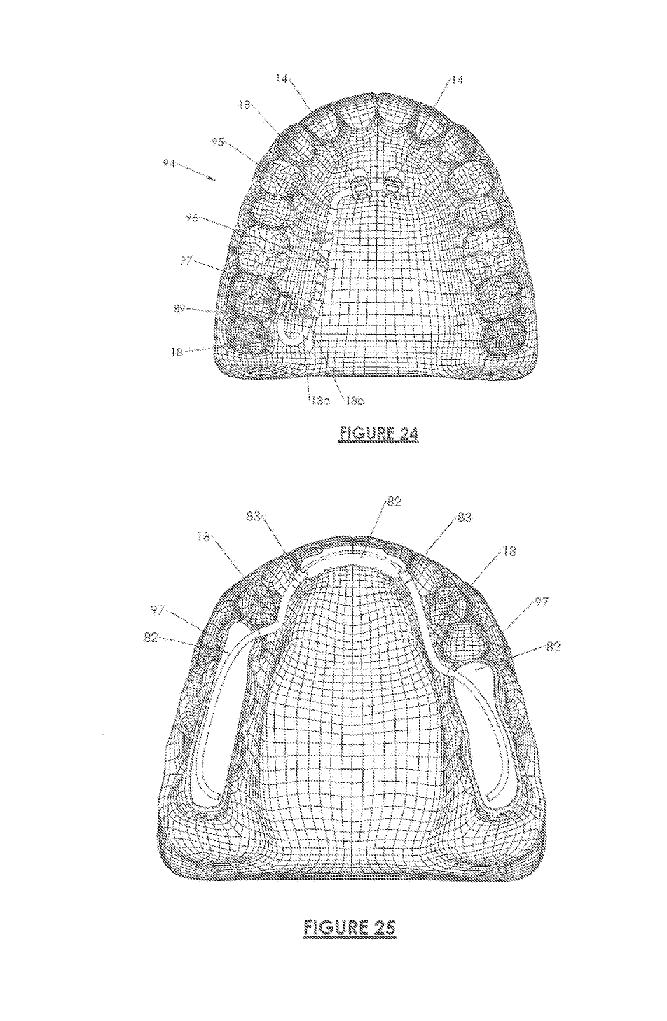

FIG. 25 is an example of a posterior molar intrusion appliance, which may or may not be removed by the patient. It consists of two FFW(s) 98, which are placed on the occlusal surfaces of the lower posterior teeth, Embedded within these FFW(s) 98 are grooves or channels, which accept and bond or mechanically hold the FFM(s) 18 in place. The FFM(s) 18 are then connected to the FFW 82 fitted to the lower anterior lingual teeth via sleeves or grooves and then extended to the opposite side of the appliance. This appliance may or may not incorporate clasps into the appliance for ease of use and retention for the patient.

Specifically, the FIG. 25 appliance to intrude posterior teeth is made in one visit at the orthodontist. It is made from two FFWs 98, which are placed and adapted to the occlusal surfaces of the lower posterior teeth. FFMs 18 are fit into channels on either of the occlusal surface as shown or underneath on the tooth borne side of the appliance. These FFMs 18 are fit to another third FFW 98 with immediate fit technology and placed on the lingual of the lower anterior teeth. Once the FFM 18 is fitted into all three FFW's 98, the appliance is cured and ready to be implemented by the patient and the orthodontist.

FIG. 26 is an example of sleeve technology 83, which is incorporated into an FFW 98 by cleats 101 which embed to the solid or acrylic portions of said FFW 98. The sleeve 83 is composed of a tube 100, which is the same or larger cross section of the FFM 18 it is to be placed there in. The sleeve 83 may or may not incorporate an opening or window for ease of curing. The opening of the tube 100 is flared 102 for easy insertion of the FFM 18. The FFM 18 is held into the sleeve 83 by a center shaft 99 with barbs, which penetrate into the FFM in its center core. The outer walls defining the lumen are also fitted with at least one directional barb(s) 103, which bite into the FFM 18. The sleeve 83 may also bond mechanically or chemically if resin is placed therein to increase bond strength.

The sleeve 83 is structured as a coping or female acceptor of the male end of an FFM 18, which is embedded into any given FFW 83 and its associated appliance by hooks or retention bars 101. The lumen of the female sleeve 98 has connecting devices which help adhere the sleeve 83 to the FFM 18, including but not limited to a center protruding mesh or rough bar that penetrates the FFM 18 at its center diameter or core. Usually, on the inside lumen walls exists biting grooves 103, which inhibit the removal of the FFM 18 when inserted into sleeve 83. The sleeve 83 opening 102 is flared as shown.

FIG. 27a is a view of an FFW 104 with cuts which perforate from the tissue side of the appliance and allow for the flexibility of the solid portion of the FFW 104 to adapt generally to curves and anatomical variations of the oral cavity and teeth. The perforations 104a only pass through the solid portion of the FFW 104 to a certain depth to allow for the appliance side to remain smooth and bendable. The perforations 104a can be configured horizontal or vertical or diagonal or in any configuration to achieve adaptability of the FFM 104 as required. The FFWs 104 can be fabricated in any shape, thickness or size as required.

FIG. 27b is a view of an FFW 104 in a contoured state showing the perforations 104a and their adaptability to a given shape. The solid portion of the FFW 92 is bent and the perforations 104a are opening on one side to give retention to the immediate fit material 93, which is now able to be adapted exactly to teeth, or soft tissue as needed.

FIG. 28 is another example of a fixed in space application positioning a fastener clamp 14 above the front teeth with looped FFM resin ropes 24 affixed to a TAD 30 to support a support wire 105 associated with an arch wire 24.

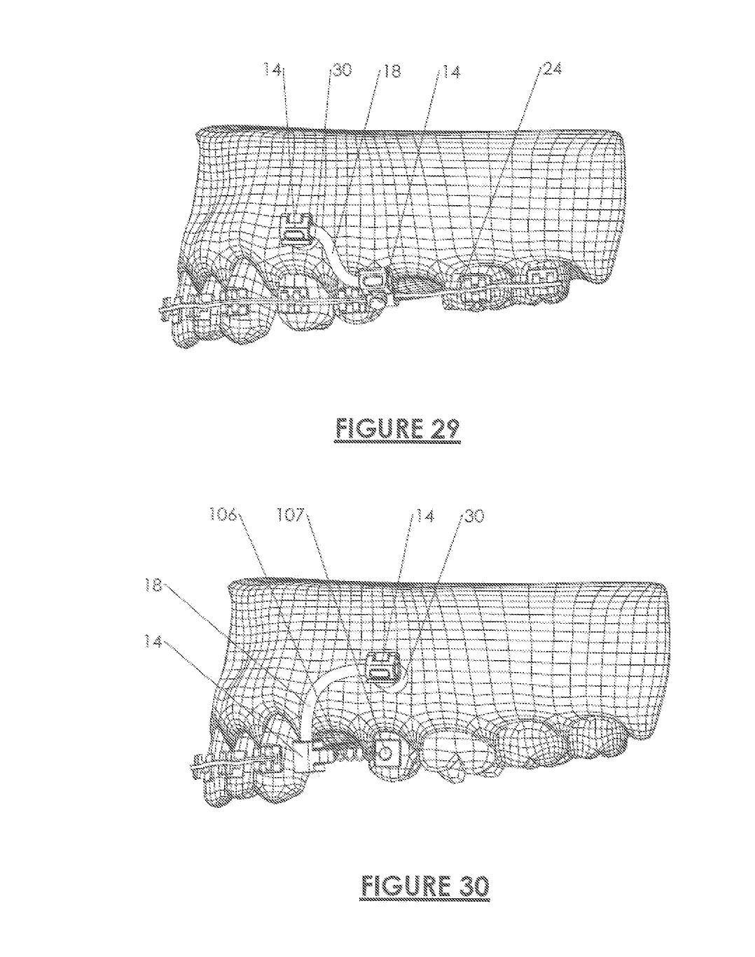

FIG. 29 is another example of a fixed in space application positioning a fastening clamp 14 affixed to a TAD 30 to support an arch wire 24 near a gap in the teeth.

FIG. 30 is still another example of a fixed in space application positioning a clamp 14 affixed to a TAD 14 to hold a tooth in position.

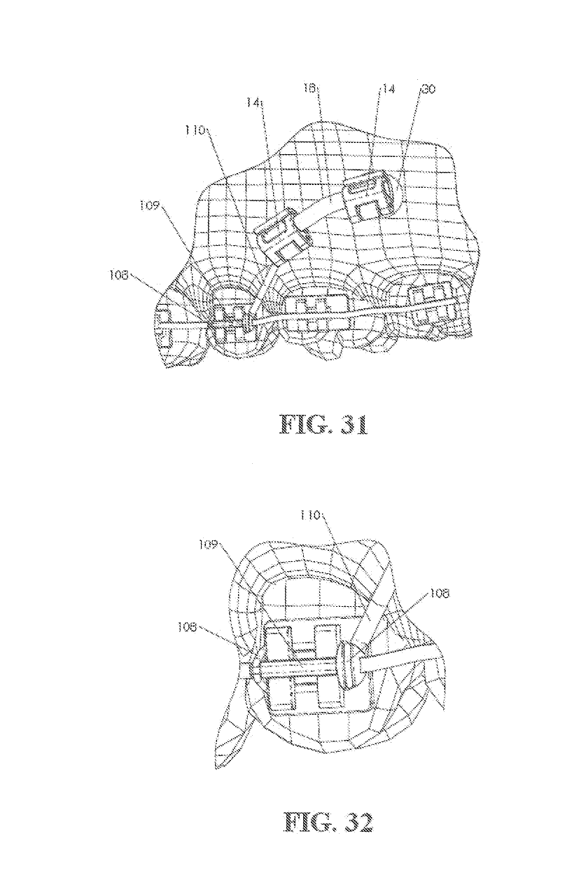

As shown in the above figures and FIGS. 31 and 32, the fasteners such as clamp 14, connect to the resin ropes 18 may be connected into the orthodontic brackets 30 via two methods:

a. a piece that snaps or fits flush with any existing bracket 110 and is either part of the bracket 110 itself and connected to the FFM structured as a bar attached to a clamp fastener 14 or b. a piece that fits flush around all or part of the bracket 110 and is held in place by an archwire 109, ligature ties 108 (elastic or metal) or via a self-ligating clip or clamp (not shown).

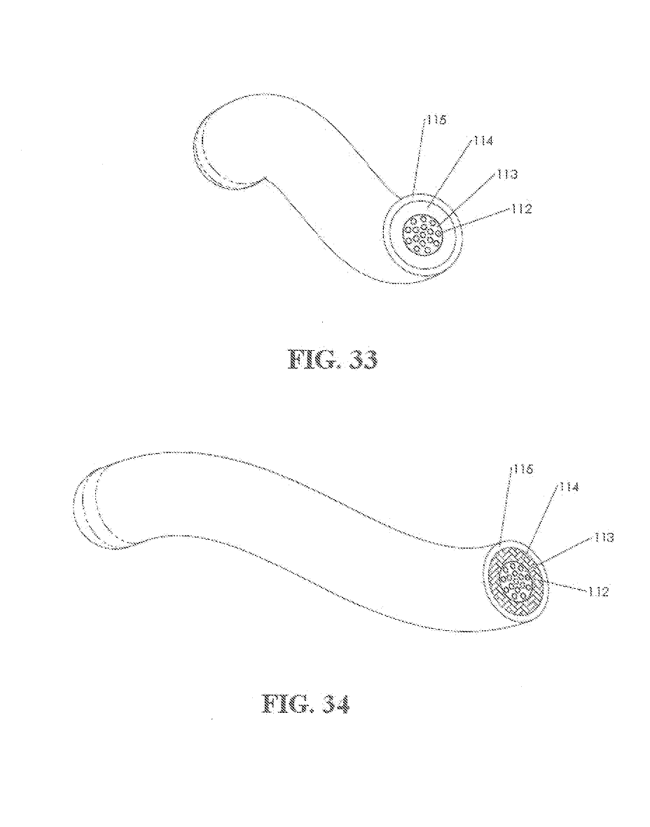

FIG. 33 illustrates another embodiment of a curable resin rope 18 with a tube 115 or encapsulated flexible wrap 115 surrounding a curable layer 114 which surrounds a resin core, which may or may not contain fibers 112 embedded in a gel, resin, or liquid resin 113. The fibers 112 may be made of a bare metal, polymer, nylon, fabric, carbon fiber, bio-resorbable or dissolvable flexible fibers.

In another embodiment, the internal core 114 is made of a flexible stent-like or structural flexible lattice as shown in FIG. 34. The flexible structural lattice material has adequate spaces between the structural fibers to allow light to penetrate the gel, or liquid resin 113, and fibers 112 or resin fiber components of the FFM flexible resin ropes 24. When the FFM flexible resin rope 24 tubing 115 or encapsulation 115 requires more flexibility, it may be scored, perforated, or cut at any given depth and in a spiral configuration or any other scoring or perforated design to allow for proper bending dynamics, flexibility, adaptability and functionality in providing ideal connectivity between the FFM tube 115 of any cross section and the components of the various appliances.

The invention thus comprises at least one FFM curable flexible resin rope 24 of varied diameters and length and of any cross section secured by TADs 16, teeth (via bands or brackets 32), connecting fasteners, FFW(s) 104, and/or appliances, each having mechanical or bondable fasteners 14 structured to secure segments of the flexible resin rope 24 to its end use attachment. The FFM resin rope 24 in a first mode is flexible and of a length to be positioned and adapted within the mouth along desired segments of the teeth, gums, palate and buccal and lingual portions of the oral cavity in both the mandible and maxilla. The FFM resin rope 24 is then attached to another clamp, sleeves, clips or embedded acrylic grooves (FFW 104) to anchor, attach, or connect to a desired structure, (i.e. TAD 12, tooth or appliance) in the oral cavity of alignment of the human dentition. IN a second mode after being placed in the desired position, the FFM resin rope 24 is cured, with or without a FFW(s) 104, and hardened with light, heat, or chemicals to rigidly hold its position during the application of the biasing pressure to the teeth (orthodontic force). This provides exact placement of desired anchorage points to teeth, TADs 12, tissue and non-tissue born appliances or points in space for the orthodontist to create desired vectors on teeth. Pulling, pushing, erupting, intruding, rotating, torque, tipping and bodily movement of teeth using braces, arch wires, TADs and tooth straightening appliances using better vector alignment move the teeth more efficiently using forces biased based on the needs of the individual patient.

This invention 10 provides a new category of custom, single visit, comfortable appliances, which maintain rigid positioning of a desired leverage point or points between teeth and appliances. Biased mechanics and anchorage requirements are now easier and more predictable while patient compliance is reduced. Because the orthodontist can custom place his appliance exactly where he needs it the orthodontic mechanics of tooth pulling, pushing, tipping, rotating, extruding, intruding and bodily movement and alignment are simplified.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

I claim:

1. Orthodontic flex fit module (FFM) resin rope(s) comprising at least one curable flexible resin rope constructed of a curable resin material capable of:
a. in a first mode,
i. molding to the anatomy of an oral cavity and segments of teeth, mucosa, hard and soft tissues of a mouth, and orthodontic appliances,
ii. holding in a molded shape until cured,
iii. securing by fasteners connected to teeth, orthodontic appliances, orthodontic auxiliaries, or oral cavity segments, and
b. in a second mode,
curing with light, heat, or chemicals to rigidly hold a molded shape to form a rigid FFM resin rope structure capable of withstanding and directing orthodontic biasing forces onto fastener secured teeth, orthodontic appliances, orthodontic auxiliaries or oral cavity segments.

2. The Orthodontic flex fit module (FFM) resin rope(s) according to claim 1, including structure capable of temporarily holding a molded shape until cured.

3. The Orthodontic flex fit module (FFM) resin rope(s) according to claim 2, wherein the structure comprises a flexible moldable skeleton associated with the curable flexible resin rope capable of holding the FFM resin rope(s) temporarily in a molded position in the first mode until cured in the second mode.

4. The Orthodontic flex fit module (FFM) resin rope(s) according to claim 3, wherein the flexible moldable skeleton comprises a bendable semi-rigid mesh exoskeleton surrounding or integrated within the curable flexible resin rope.

5. The Orthodontic flex fit module (FFM) resin rope(s) according to claim 3, wherein the flexible moldable skeleton comprises a bendable endoskeleton.

6. The Orthodontic flex fit module (FFM) resin rope(s) according to claim 1, wherein the FFM resin rope(s) resin material is of uniform composition with embedded fibers capable of holding in a molded shape until cured and of affixing to fasteners or connecting devices.

7. The Orthodontic flex fit module (FFM) resin rope(s) according to claim 1, wherein the curable flexible resin rope comprises:
i. a flexible resin tube or encapsulation wrapping surrounding a core, and
ii. resin core encapsulation materials containing fibers, gels, flakes, and particles filling the core to enhance handling or strength properties of the flexible resin rope.

8. The Orthodontic flex fit module (FFM) or flexible resin rope(s) according to claim 7, wherein the resin core encapsulation materials are selected from the group consisting of: 2,6-Di-tert-butyle-4-methylphenol, Bisphenol A ethoxylate dimethacrylate, PEG 400 Extended Urethane dimethacrylate, Aliphatic Urethane Acrylate, Urethane dimethacrylate, Diurethane dimethacrylate isomers mixtures, Ethyl 4-(dimethlyamineo) benzoate, epoxies, acrylates, cyanoacrylates, silicones, polyurethanes, polyureas, oligomer acrylates, urethane methacrylate oligomers, low molecular weight trimethacrylates or other polyethylene glycol (PEG) monomers, Bisphenol A glycerolate dimethacrylate, and photo initiators.

9. The Orthodontic flex fit module (FFM) resin rope(s) according to claim 7, wherein the resin tube or encapsulation wrapping is selected from the group consisting of a metal mesh, a fluoropolymer, rubber, plastic, and fibrous resin mesh material for different orthodontic applications.

10. The Orthodontic flex fit module (FFM) resin rope(s) according to claim 4, wherein the exoskeleton is made of a metal stent like tube with a perforated structure or lattice or of woven fiber mesh spaced sufficiently apart to allow light to penetrate the core encapsulation materials for curing.

11. The Orthodontic flex fit module (FFM) resin rope(s) according to claim 4, wherein the exoskeleton is made of woven fiber mesh spaced sufficiently apart to allow light to penetrate the core encapsulation materials for curing.

12. The Orthodontic flex fit module (FFM) resin rope(s) according to claim 7, wherein the flexible resin tube or encapsulation wrapping may be scored, perforated, or cut at a depth and pattern for manipulation flexibility and smoother contours.

13. The Orthodontic flex fit module (FFM) resin rope(s) according to claim 1, wherein the FFM flexible resin ropes have differing cross-sectional dimensions, shapes, and sizes selected to provide varied strengths, ease of use, or contact with different hard or soft tissue structures of the oral cavity for a better anatomical fit.

14. The Orthodontic flex fit module (FFM) resin rope(s) according to claim 1, for constructing orthodontic appliances including:
a. anchoring structures with fasteners structured to secure to segments of the FFM flexible resin ropes affixed from temporary anchoring devices (TADS) and/or tooth positioning appliances and/or braces and/or wires and/or tissue contacting interfaces within the oral cavity to connect to teeth, appliances, between components of orthodontic appliances, or to connect to an orthodontic auxiliary at a fixed point in space, allowing application or negation of orthodontic forces to teeth or other oral cavity segments, and
b. biasing springs, elastics, elastomeric ties or ligatures, and orthodontic wire, affixed to the anatomical anchoring structures to form an orthodontic system or appliance when fastened together and cured.
